(19) United States
(12) Patent Application Publication
(10) Pub. No.: US 2024/0288332 A1
(43) Pub. Date: Aug. 29, 2024

(54) FLOW SENSOR

(71) Applicant: Keyence Corporation, Osaka (JP)

(72) Inventors: Masaki ISHIHARA, Osaka (JP); Yuta KATO, Osaka (JP); Masashi KAWANAKA, Osaka (JP); Shinichi TSUKIGI, Osaka (JP)

(73) Assignee: Keyence Corporation, Osaka (JP)

(21) Appl. No.: 18/411,080

(22) Filed: Jan. 12, 2024

(30) Foreign Application Priority Data
Feb. 28, 2023 (JP) 2023-029138

(51) Int. Cl. G01M 3/26

(52) U.S. Cl. CPC G01M 3/26

(57) ABSTRACT

It is possible to perform prompt and accurate diagnosis of a pneumatic device while mitigating a burden on a user at the time of introduction. A flow sensor includes: a flow rate measuring element for measuring a flow rate of a working gas in a pipe; a pressure measuring element for measuring a pressure of the working gas in the pipe; and an evaluation unit that determines a characteristic amount indicating an operation of the pneumatic device based on a combination of the flow rate measured by the flow rate measuring element and the pressure measured by the pressure measuring element, and evaluates the operation of the pneumatic device based on the determined characteristic amount.

### CROSS-REFERENCE TO RELATED APPLICATIONS

The present application claims foreign priority based on Japanese Patent Application No. 2023-029138, filed Feb. 28, 2023, the contents of which are incorporated herein by reference.

### BACKGROUND OF THE INVENTION

### 1. TECHNICAL FIELD

The disclosure relates to a flow sensor capable of measuring a flow rate of a working gas flowing in a pipe connected to a pneumatic device.

### 2. DESCRIPTION OF THE RELATED ART

For example, in manufacturing sites for manufacturing various products, pneumatic devices, such as an air blowing device, an air cylinder device, a workpiece suction conveying device, and a workpiece seating device, are used. In general, a pipe to which compressed air is supplied is connected to a pneumatic device, and a supply source of the compressed air is connected to the pipe.

Further, as a flow sensor that measures a flow rate of a gas flowing in the pipe, for example, a sensor disclosed in JP 2020-109360 A is known.

Meanwhile, in a manufacturing facility using a pneumatic device, manufacturing conditions are likely to change due to a decrease in supplied air pressure, deterioration of the pneumatic device, or the like.

If the manufacturing conditions are out of initially set allowable ranges, the device is stopped, leading to a loss.

In this regard, it is conceivable that a user independently makes and operates a diagnosis system that diagnoses the pneumatic device, but a lot of time and cost are required for the preparation and setting at the time of introduction of the diagnosis system. Further, diagnosis is performed with only one physical quantity in an existing diagnosis system, and a case in which it is difficult to promptly and accurately determine the presence or absence of a defect is conceivable. That is, there is a method of measuring a movement time and diagnosing the presence or absence of a defect based on the measured movement time in a case where diagnosis of an air cylinder device that drives a member is performed, but it is difficult to promptly grasp the generation of the defect because a change in the movement time rapidly progresses as a leakage amount of compressed air increases.

Further, there is a method of measuring a pressure and diagnosing the presence or absence of a defect based on the measured pressure in a where diagnosis of a suction conveying device is performed. However, when a pressure loss of the pipe of the compressed air increases, a temporal change of the pressure is delayed, but a vacuum pressure (suction force) in a suction unit does not change, and the vacuum pressure in the suction unit changes only slightly even if a leakage occurs in the pipe. Thus, it is difficult to accurately determine the presence or absence of a defect. Further, in a case where diagnosis of an air blowing device is performed, a pressure loss increases as a flow rate increases, and manufacturing conditions also change greatly. Thus, it is difficult to accurately determine the presence or absence of a defect.

### SUMMARY OF THE INVENTION

The disclosure has been made in view of such points, and an object thereof is to enable prompt and accurate diagnosis of a pneumatic device while mitigating a burden on a user at the time of introduction.

In order to achieve the above object, according to one embodiment, a flow sensor includes: a flow rate measuring element configured to measure a flow rate of a working gas in a pipe connected to a pneumatic device and forming a flow path of the working gas; a pressure measuring element configured to measure a pressure of the working gas in the pipe; and an evaluation unit that determines a characteristic amount indicating an operation of the pneumatic device based on a combination of the flow rate measured by the flow rate measuring element and the pressure measured by the pressure measuring element, and evaluates the operation of the pneumatic device to which the pipe is connected based on the characteristic amount.

According to the flow sensor, it is possible to measure the flow rate and the pressure of the working gas flowing through the flow path in the pipe connected to the pneumatic device. Since the evaluation unit that evaluates the operation of the pneumatic device is provided in the flow sensor, diagnosis of the pneumatic device can be performed using the flow sensor without causing a user to separately prepare a diagnosis system for diagnosing the pneumatic device, and thus, a burden of introducing the diagnosis system for the pneumatic device is mitigated. Further, since the flow rate measuring element for measuring the flow rate of the working gas in the pipe and the pressure measuring element for measuring the pressure of the working gas in the pipe are provided, the evaluation unit can determine the characteristic amount indicating the operation of the pneumatic device using the combination of the flow rate and the pressure, and can evaluate the operation of the pneumatic device based on the determined characteristic amount. As a result, it is possible to perform prompt and accurate diagnosis as compared with a conventional case where the diagnosis is performed using only one physical quantity.

The pipe may be configured to be connectable to any one pneumatic device among, for example, an air blowing device, an air cylinder device, a suction conveying device, a seating device, and the like as a plurality of types of the pneumatic devices. In this case, the evaluation unit can determine a characteristic amount corresponding to a type of the pneumatic device connected to the pipe, and evaluate an operation of the pneumatic device connected to the pipe based on the characteristic amount. Thus, it is possible to provide a highly versatile flow sensor capable of evaluating operations of the plurality of types of pneumatic devices.

A reception unit that receives selection of a type of the pneumatic device connected to the pipe from the user may be further included. In this case, the evaluation unit can determine a characteristic amount corresponding to the type of the pneumatic device received by the reception unit, and evaluate an operation of the pneumatic device connected to the pipe based on the characteristic amount.

In a case where the air blowing device that ejects air as the working gas from a nozzle is connected to the pipe, the evaluation unit can determine a blowing amount, which is a mass flow rate of compressed air ejected from the nozzle of the air blowing device, as the characteristic amount, and evaluate an operation of the air blowing device based on the blowing amount. For example, the evaluation unit may evaluate that clogging of the nozzle occurs in a case where the blowing amount is equal to or less than a predetermined blowing amount and the pressure measured by the pressure measuring element is equal to or more than a reference pressure. Further, the evaluation unit may evaluate that a pressure drop of the compressed air supplied to the air blowing device occurs in a case where the blowing amount is equal to or less than the predetermined blowing amount and the pressure measured by the pressure measuring element is less than the reference pressure. As a result, it is possible to distinguish between the clogging of the nozzle and the pressure drop.

In a case where the air cylinder device is connected to the pipe, the evaluation unit can determine a leakage amount and a thrust margin of the air cylinder device as the characteristic amount, and evaluate an operation of the air cylinder device based on the leakage amount and the thrust margin. For example, in a case where the leakage amount when the air cylinder device is stopped is equal to or more than a predetermined leakage amount, the evaluation unit can evaluate that deterioration of packing of the air cylinder device occurs.

In a case where the suction conveying device using a pressure of air as the working gas is connected to the pipe, the evaluation unit can determine a suction speed of the suction conveying device and a suction force of the suction conveying device as the characteristic amount, and evaluate an operation of the suction conveying device based on the suction speed and the suction force. In this case, when the suction force during suction is equal to or less than a predetermined force, the evaluation unit may evaluate that deterioration of a suction pad included in the suction conveying device occurs. In a case where the flow rate measured by the flow rate measuring element is equal to or less than a predetermined flow rate during suction, it is possible to evaluate that a pressure drop of the compressed air supplied to the suction conveying device or clogging of a flow path in the suction conveying device occurs.

In a case where the seating device using compressed air as the working gas is connected to the pipe, the evaluation unit can determine a volume flow rate of the compressed air ejected from the seating device as the characteristic amount, and evaluate an operation of the seating device based on the volume flow rate.

In this case, in a case where the volume flow rate when the workpiece is not seated is equal to or less than a predetermined flow rate and the pressure measured by the pressure measuring element is within a predetermined range, the evaluation unit can evaluate that clogging of a nozzle of the seating device occurs. Further, in a case where the volume flow rate when the workpiece is not seated is equal to or less than the predetermined flow rate and the pressure measured by the pressure measuring element drops below the predetermined range, the evaluation unit may evaluate that a pressure drop of the compressed air supplied to the seating device occurs.

The evaluation unit may determine the characteristic amount indicating the operation of the pneumatic device based on a combination of time-series data of the flow rate measured by the flow rate measuring element and time-series data of the pressure measured by the pressure measuring element. As a result, the characteristic amount can be determined using the progress of the flow rate and the pressure.

The evaluation unit can also execute reference value determination processing of determining an evaluation reference value using a plurality of the flow rates and a plurality of the pressures respectively measured by the flow rate measuring element and the pressure measuring element when the pneumatic device repeats the operation, and perform the evaluation based on the determined evaluation reference value. That is, it is possible to obtain the evaluation reference value with a high degree of reliability by determining the evaluation reference value using the plurality of flow rates and the plurality of pressures.

The evaluation unit may repeatedly execute the reference value determination processing using the flow rate and the pressure acquired at a plurality of different timings until a degree of reliability of the evaluation reference value is equal to or higher than a predetermined degree of reliability. As a result, the degree of reliability of the evaluation reference value can be enhanced.

Since the flow sensor includes the evaluation unit that determines the characteristic amount indicating the operation of the pneumatic device based on the combination of the flow rate measured by the flow rate measuring element and the pressure measured by the pressure measuring element and evaluates the operation of the pneumatic device based on the characteristic amount as described above, it is possible to promptly and accurately diagnose the pneumatic device while mitigating the burden on the user at the time of introduction.

### BRIEF DESCRIPTION OF THE DRAWINGS

FIG. 1 is a perspective view of a flow sensor according to an embodiment of the invention;

FIG. 2 is a perspective view illustrating a state before a clamp-on type ultrasonic flowmeter is attached to a pipe;

FIG. 3 is an end view of the clamp-on type ultrasonic flowmeter;

FIG. 4 is a sectional view taken along line IV-IV in FIG. 3;

FIG. 5 is a view corresponding to FIG. 4 and illustrating a pipe built-in type flowmeter;

FIG. 6 is a perspective view illustrating a state where a housing of the pipe built-in type flowmeter is omitted;

FIG. 7 is a block diagram of a control unit;

FIG. 8 is a view illustrating a display example of an application selection screen;

FIG. 9 is a flowchart illustrating an example of a procedure of processing of determining an operating state of an air blowing device;

FIG. 10A illustrates a measurement value display screen in the case of the air blowing device, FIG. 10B illustrates a flow rate threshold setting screen, and FIG. 10C illustrates a pressure threshold setting screen;

FIGS. 11A and 11B are graphs each illustrating a relationship between a flow rate and a pressure used in a case where the air blowing device is diagnosed;

FIG. 12A illustrates an alarm screen indicating that clogging of a nozzle occurs, and FIG. 12B illustrates an alar m screen indicating that an original pressure drop occurs;

FIG. 13 is a flowchart illustrating an example of a processing of a process of determining an operating state of an air cylinder device;

FIG. 14A is a measurement value display screen in the case of the air cylinder device, FIG. 14B is a leakage amount display screen, and FIG. 14C is a thrust margin display screen;

FIG. 15 is a view for describing a relationship between an operation of the air cylinder device and a flow rate and a pressure of a working gas;

FIG. 16 is a view for describing a relationship between an operation of the air cylinder device and a flow rate of the working gas in a case where a leakage from packing occurs;

FIG. 17 is a view illustrating fluctuations in a thrust margin when a load increases;

FIG. 18A illustrates an alarm screen indicating that a leakage amount increases, and FIG. 18B illustrates an alarm screen indicating that the thrust margin has decreased;

FIG. 19 is a flowchart illustrating an example of a procedure of processing of determining an operating state of a suction conveying device;

FIG. 20A illustrates a measurement value display screen in the case of the suction conveying device, FIG. 20B illustrates a suction speed threshold setting screen, and FIG. 20C illustrates a suction force threshold setting screen;

FIG. 21 is a view for describing a relationship between an operation of the suction conveying device and a flow rate and a pressure of a working gas;

FIG. 22 is a view for describing a relationship between an operation of the suction conveying device and a flow rate and a pressure of the working gas in a case where a filter is clogged;

FIG. 23 is a view for describing a relationship between an operation of the suction conveying device and a flow rate and a pressure of the working gas in a case where a suction pad has been deteriorated;

FIG. 24A illustrates an alarm screen indicating that a suction speed decreases, and FIG. 24B illustrates an alarm screen indicating that a suction force has decreased;

FIG. 25 is a flowchart illustrating an example of a procedure of processing of determining an operating state of a seating device;

FIG. 26A illustrates a measurement value display screen in the case of a seating device, and FIG. 26B illustrates a flow rate threshold setting screen;

FIGS. 27A and 27B are graphs each illustrating a relationship between a flow rate and a pressure used in a case where the seating device is diagnosed;

FIGS. 28A and 28B are graphs illustrating time-series changes in the flow rate and the pressure, respectively; and

FIG. 29 is a view illustrating an example of an evaluation method using trend monitoring.

### DETAILED DESCRIPTION

Hereinafter, an embodiment of the invention will be described in detail with reference to the drawings. Note that the following description of the preferred embodiment is merely an example in essence, and is not intended to limit the invention, its application, or its use.

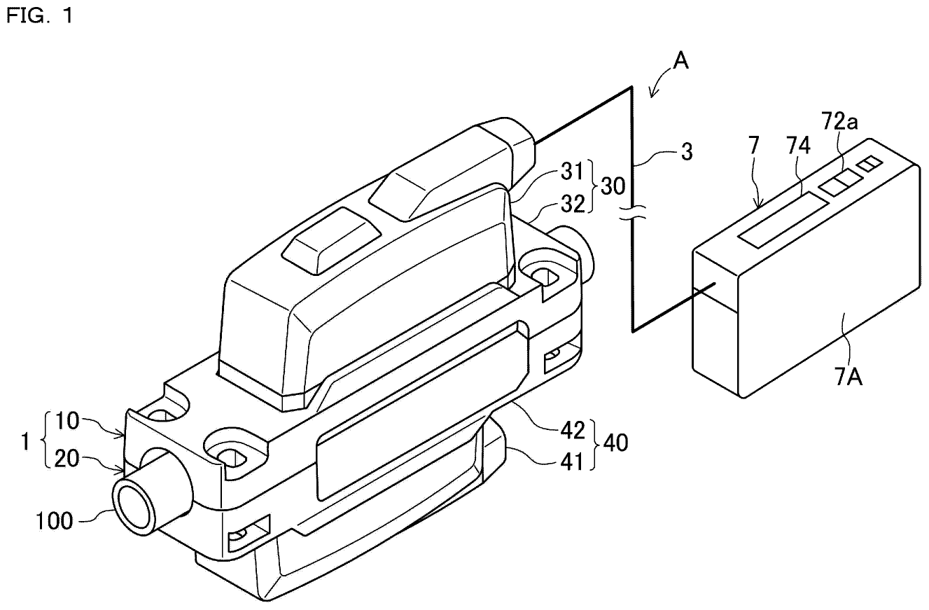

FIG. 1 illustrates a flow sensor A according to the embodiment of the invention. The flow sensor A includes a flowmeter 1 and a control unit 7. The flowmeter 1 is a part that is connected to pneumatic devices and measures a flow rate of a working gas in a pipe 100 forming a flow path of the working gas. The control unit 7 controls the flowmeter 1, and executes conversion processing of converting various signals sent from the flowmeter 1 into a flow rate and a pressure, evaluation processing of evaluating an operation state of the pneumatic device, and the like.

The pipe 100 is a non-metallic pipe made of a non-metallic material. Examples of the material thereof can include a resin material, and the resin pipe 100 is obtained when the resin material is used. Examples of the resin material forming the pipe 100 include nylon, Teflon (registered trademark), polyurethane, and the like, and any of these materials can be used.

The pneumatic devices to which the pipe 100 is connected are not particularly limited, and include a plurality of types of pneumatic devices. That is, the pneumatic devices include, for example, an air blowing device, an air cylinder device, a suction conveying device, a seating device, and the like, and the pipe 100 is configured to be connectable to any pneumatic device among the plurality of types of pneumatic devices.

The air blowing device includes a nozzle, and is configured to eject compressed air as a working gas from the nozzle. The air cylinder device is configured to be capable of advancing and retracting a rod from a cylinder using a pressure of compressed air. Advancing can also be referred to as pushing, and retracting can also be referred to as drawing.

The suction conveying device is configured to be capable of generating a negative pressure using a pressure of compressed air as a working gas, sucking a workpiece or the like placed at a certain place, and conveying the workpiece or the like to another place. The seating device has an ejection port that ejects compressed air as a working gas, and is configured to be capable of detecting that, for example, a workpiece or the like is placed and blocked in the ejection port. These pneumatic devices are supplied with the compressed air, such as factory air, in a state of being adjusted to a predetermined pressure from a supply source via the pipe 100.

The flowmeter 1 and the control unit 7 are separately provided, and are connected to be capable of communicating with each other by a connection line 3. Since the flowmeter 1 and the control unit 7 are separately provided, particularly the flowmeter 1 can be downsized, and a degree of freedom in installation on the pipe 100 can be improved. Further, power is supplied from a power source (not illustrated) to the control unit 7, and the power supplied to the control unit 7 is supplied to the flowmeter 1 via the connection line 3 in the present embodiment. However, the invention is not limited thereto, and power may be supplied from the power source to the flowmeter 1. Note that the flowmeter 1 and the control unit 7 may be integrated.

First, a configuration of the flowmeter 1 will be described. Although a case where the flowmeter 1 is an ultrasonic flowmeter that measures a flow rate using an ultrasonic signal will be described in the present embodiment, the flowmeter 1 is not limited to the ultrasonic flowmeter, and may be a flowmeter using another measurement principle such as a thermal flowmeter. Further, as the ultrasonic flowmeter 1, there are a clamp-on flowmeter detachably attached to the pipe 100 and a flowmeter including a built-in pipe, and the invention can be applied to any flowmeter. That is, the configuration of the flowmeter 1 is not limited to the following configuration, and may have any configuration. Hereinafter, the clamp-on flowmeter and the flowmeter including the built-in pipe will be described in this order.

### Configuration of Clamp-On Type Flowmeter

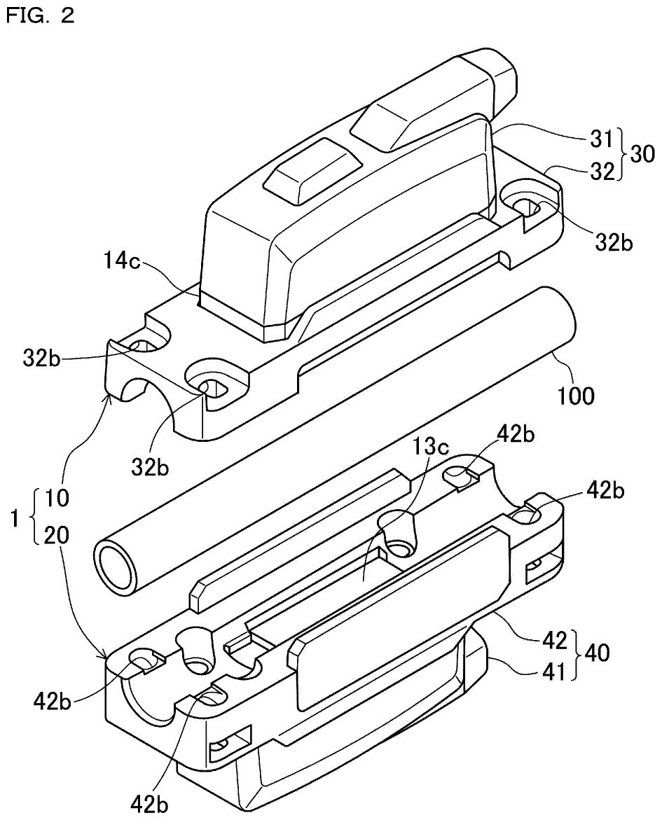

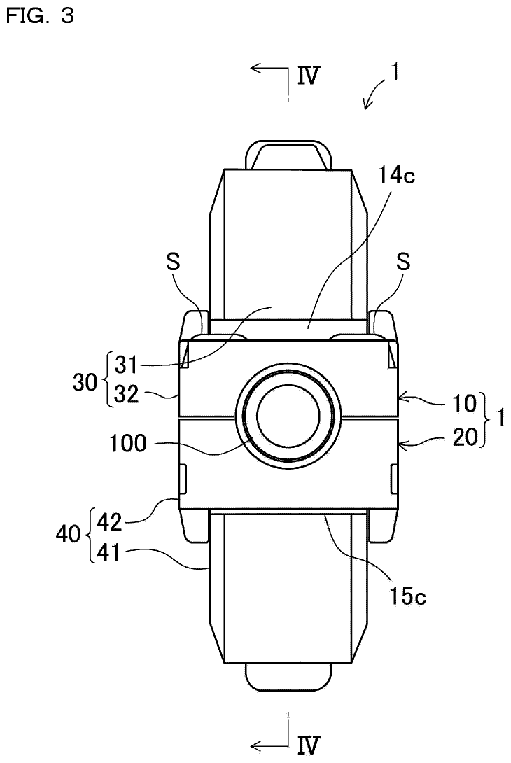

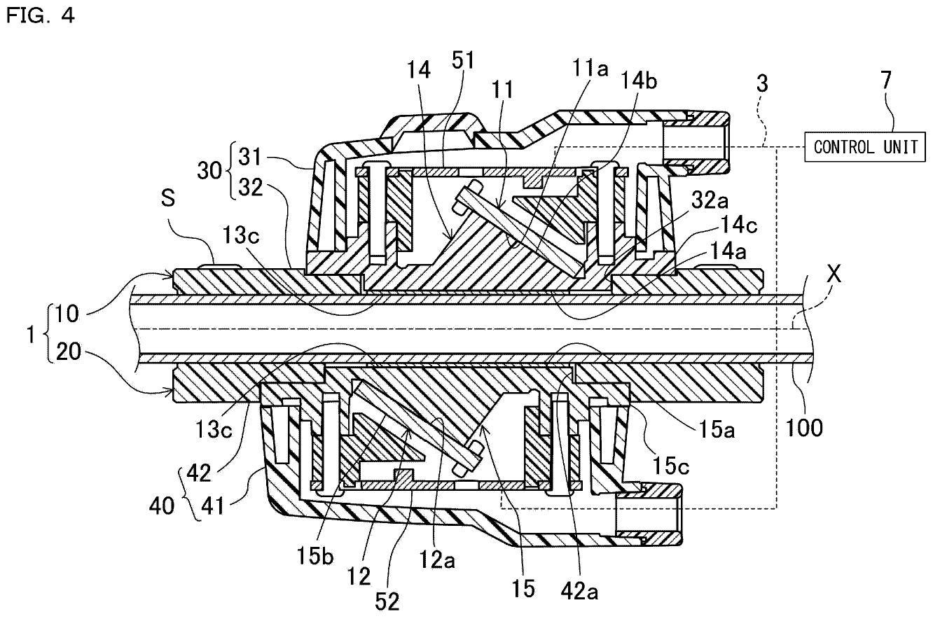

As illustrated in FIG. 2, the clamp-on flowmeter 1 includes a first divided body 10 and a second divided body 20 that can be separated from each other. As illustrated in FIGS. 3 and 4, the pipe 100 is sandwiched from both sides in the radial direction by the first divided body 10 and the second divided body 20. Further, in the description of this embodiment, the “upstream” and the “downstream” are defined with a flow direction of the working gas in the pipe 100 as a reference, but this definition is for convenience of description only, and does not limit the invention. Further, the upper side in FIGS. 2 to 4 is referred to as the “up” of the ultrasonic flowmeter 1, and the lower side in FIGS. 2 to 4 is referred to as the “down” of the ultrasonic flowmeter 1, but this is also for convenience of description only, and does not limit the invention.

As illustrated in FIG. 4, the ultrasonic flowmeter 1 includes a first ultrasonic element 11, a second ultrasonic element 12, a first wedge member 14, and a second wedge member 15. The first ultrasonic element 11 and the second ultrasonic element 12 are flow rate measuring elements for measuring the flow rate of the working gas in the pipe 100, and specifically, the both are configured using, for example, a piezoelectric element as an element that transmits and receives the ultrasonic signal. The first ultrasonic element 11 is located on one side in the radial direction (the upper side in FIG. 4) outside the pipe 100, and has a transmission/reception surface 11a that transmits and receives the ultrasonic signal. Further, the second ultrasonic element 12 is located on the other side in the radial direction (the lower side in FIG. 4) outside the pipe 100, and has a transmission/reception surface 12a that transmits and receives the ultrasonic signal.

The first wedge member 14 propagates the ultrasonic signal between the first ultrasonic element 11 and the pipe 100, and is arranged between the first ultrasonic element 11 and the pipe 100 outside the pipe 100. The first wedge member 14 has a pipe-side surface 14a opposing an outer surface of the pipe 100 and an element-side surface 14b opposing the transmission/reception surface 11a of the first ultrasonic element 11. An acoustic coupling member 13c configured using a viscoelastic body made of, for example, rubber, grease, or the like is interposed between the pipe-side surface 14a of the first wedge member 14 and the outer surface of the pipe 100.

The second wedge member 15 propagates the ultrasonic signal between the second ultrasonic element 12 and the pipe 100, and is arranged between the second ultrasonic element 12 and the pipe 100 outside the pipe 100. The second wedge member 15 has a pipe-side surface 15a opposing the outer surface of the pipe 100 and an element-side surface 15b opposing the transmission/reception surface 12a of the second ultrasonic element 12. The acoustic coupling member 13c is also interposed between the pipe-side surface 15a of the second wedge member 15 and the outer surface of the pipe 100.

The first divided body 10 includes the first ultrasonic element 11, the first wedge member 14, and a first housing 30 that accommodates the first ultrasonic element 11 and the first wedge member 14. The first housing 30 includes a first box-shaped portion 31 and a first base portion 32. A first attachment plate portion 14c is provided at a peripheral edge portion of the first wedge member 14. The first attachment plate portion 14c is fixed to the first box-shaped portion 31 or the first base portion 32.

The first base portion 32 is arranged below the first box-shaped portion 31 and is integrated with the first box-shaped portion 31. As illustrated in FIG. 3, a first open port 32a is formed in a central portion of the first base portion 32. The pipe-side surface 14a of the first wedge member 14 is arranged so as to face downward through the first open port 32a. As illustrated in FIG. 2, screw insertion holes 32b through which screws S only partially illustrated in FIG. 3 are inserted are formed on both the sides of the first base portion 32 in the longitudinal direction.

As illustrated in FIG. 4, the second divided body 20 includes the second ultrasonic element 12, the second wedge member 15, and a second housing 40 that accommodates the second ultrasonic element 12 and the second wedge member 15. The second housing 40 includes a second box-shaped portion 41 and a second base portion 42. As illustrated in FIG. 4, a second open port 42a is formed in a central portion of the second base portion 42. The pipe-side surface 15a of the second wedge member 15 is arranged so as to face upward through the second open port 42a.

As illustrated in FIG. 2, both sides of the second base portion 42 in the longitudinal direction are formed so as to extend from the second box-shaped portion 41. Screw insertion holes 42b through which the screws S that has been inserted into the screw insertion holes 32b of the first base portion 32 are inserted are formed on both the sides of the second base portion 42 in the longitudinal direction. Nuts (not illustrated) are screwed to the screws S inserted into the screw insertion holes 42b. As illustrated in FIG. 4, the first housing 30 and the second housing 40 of the ultrasonic flowmeter 1 are arranged so as to sandwich the pipe 100 in the radial direction, and are coupled to each other by the screws S (illustrated in FIG. 3).

As illustrated in FIG. 4, the ultrasonic flowmeter 1 further includes a first circuit board 51 and a second circuit board 52. Further, the first circuit board 51 is connected to the first ultrasonic element 11, and the second circuit board 52 is connected to the second ultrasonic element 12.

Although not illustrated, the ultrasonic flowmeter 1 may include a pressure measuring element for measuring a pressure of the working gas in the pipe 100. The pressure measuring element is configured using, for example, a strain gauge or the like, and is configured to convert the pressure of the working gas into an electric signal and output the electric signal. The pressure measuring element may be integrated with a body part of the ultrasonic flowmeter 1 or may be separately provided.

### Configuration of Flowmeter Including Built-In Pipe

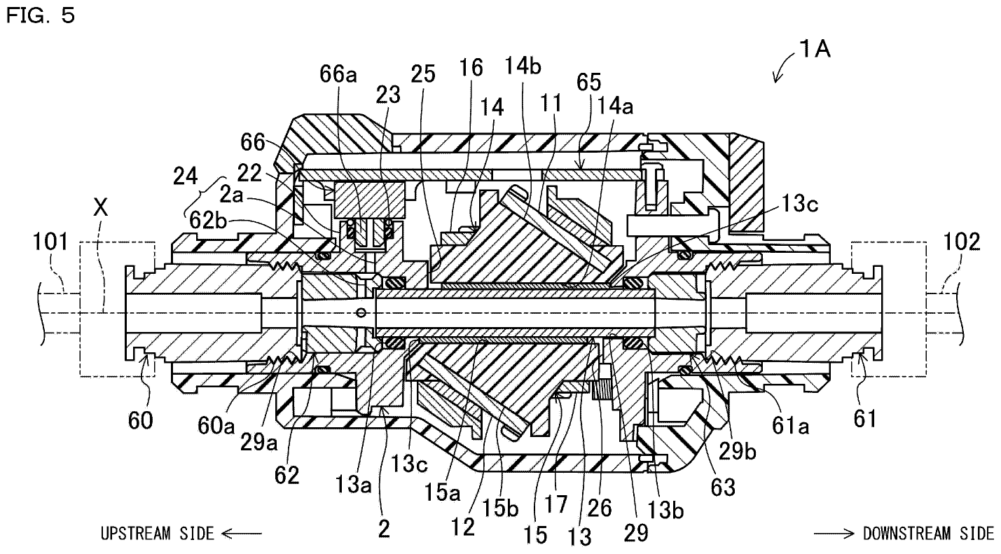

In FIGS. 5 and 6, a flowmeter (referred to as a pipe built-in type flowmeter) 1A including a built-in pipe 13, the same parts as those of the clamp-on flowmeter 1 will be denoted by the same reference signs, description thereof will be omitted, and different parts will be described in detail.

As illustrated in FIG. 5, the pipe built-in type flowmeter 1A also includes the built-in pipe 13 as a part of components, and is provided between an upstream external pipe 101 and a downstream external pipe 102. The upstream external pipe 101 is an external pipe located upstream of the pipe built-in type flowmeter 1A, and the downstream external pipe 102 is an external pipe located downstream of the pipe built-in type flowmeter 1A. The upstream external pipe 101 and the downstream external pipe 102 are made of the same material as the pipe 100.

When the pipe built-in type flowmeter 1A is installed, a portion of an existing pipe is cut, and then, the pipe built-in type flowmeter 1A can be installed between the upstream external pipe 101 and the downstream external pipe 102 with an upstream side of the cut portion as the upstream external pipe 101 and a downstream side of the cut portion as the downstream external pipe 102. That is, the pipe built-in type flowmeter 1A can be installed by cutting the existing pipe. Note that the pipe built-in type flowmeter 1A can be incorporated in a pneumatic device when the pneumatic device is newly installed.

The built-in pipe 13 forms a flow path through which the working gas flows, is made of a member that attenuates the ultrasonic signals transmitted from the first ultrasonic element 11 and the second ultrasonic element 12, and can also be referred to as a damping pipe. Specifically, the built-in pipe 13 is made of, for example, nylon, Teflon, polyurethane, or the like as a material having an ultrasonic signal attenuation capacity, and is made of a material softer than materials forming the first wedge member 14 and the second wedge member 15.

The first ultrasonic element 11 and the second ultrasonic element 12 are located outside the built-in pipe 13. The first wedge member 14 is arranged between the first ultrasonic element 11 and the built-in pipe 13. An acoustic coupling member 13c is interposed between the built-in pipe 13 and the first wedge member 14. The second wedge member 15 is arranged between the second ultrasonic element 12 and the built-in pipe 13. Therefore, the flow rate of the working gas is measured during the flow through the flow path of the built-in pipe 13.

The pipe built-in type flowmeter 1A further includes a center block 2 having a shape elongated in the flow direction of the working gas. The center block 2 is made of a highly rigid member such as metal or hard resin. The built-in pipe 13 is made of a material softer than a material forming the center block 2, and has a higher ultrasonic signal attenuation capacity than the material forming the center block 2.

In the center block 2, an insertion hole 29 into which the built-in pipe 13 is inserted is formed to penetrate in the flow direction of the working gas. The upstream part and the downstream part of the built-in pipe 13 are fixed to the center block 2 in a state of being inserted into the insertion hole 29. Further, the first wedge member 14 and the second wedge member 15 are also fixed to the center block 2.

A first opening 25 into which the first wedge member 14 on the built-in pipe 13 side is inserted is formed in the center block 2. As illustrated in FIG. 6, a first flange portion 14c superimposed on an outer surface of the center block 2 is formed on the first wedge member 14. A first holder 16 is superimposed on the first flange portion 14c. A screw insertion hole 16a through which a fixing screw (not illustrated) is inserted is formed in the first holder 16. The screw inserted into the screw insertion hole 16a penetrates through the first flange portion 14c of the first wedge member 14 and is screwed into the center block 2. As a result, the first wedge member 14 is fastened and fixed to the center block 2.

Further, a second opening 26 into which the second wedge member 15 on the built-in pipe 13 side is inserted is formed in the center block 2. As illustrated in FIG. 6, a second flange portion 15c superimposed on the outer surface of the center block 2 is formed on the second wedge member 15. The second holder 17 is superimposed on the second flange portion 15c. A screw insertion hole (not illustrated) through which a fixing screw (not illustrated) is inserted is formed in second holder 17. Therefore, similarly to the first wedge member 14, the second wedge member 15 can be fastened and fixed to the center block 2.

As illustrated in FIG. 5, the pipe built-in type flowmeter 1A further includes an upstream connection portion 60, a downstream connection portion 61, an upstream pipeline member 62, and a downstream pipeline member 63. The upstream connection portion 60, the upstream pipeline member 62, the built-in pipe 13, the downstream pipeline member 63, and the downstream connection portion 61 are arranged sequentially from the upstream side to the downstream side in the flow direction of the working gas. Note that the upstream pipeline member 62 and the downstream pipeline member 63 are provided as necessary, and may be omitted.

An upstream pipe sealing member 13a and a downstream pipe sealing member 13b, which are O-rings, are provided in close contact with outer surfaces of the upstream part and the downstream part of the built-in pipe 13, respectively. The upstream pipe sealing member 13a is in close contact with an inner surface on the upstream side of the insertion hole 29, and a space between the upstream part of the built-in pipe 13 and the insertion hole 29 is sealed by the upstream pipe sealing member 13a. Further, the downstream pipe sealing member 13b is in close contact with an inner surface on the downstream side of the insertion hole 29, and a space between the downstream part of the built-in pipe 13 and the insertion hole 29 is sealed by the downstream pipe sealing member 13b.

The upstream connection portion 60 is a member for connection with the upstream external pipe 101 so as to make a flow path of the upstream external pipe 101 and the flow path of the built-in pipe 13 communicate with each other. For example, a screw thread 60a is formed on an outer peripheral surface on the downstream side of the upstream connection portion 60. The screw thread 60a is screwed into a screw groove 29a formed on an inner peripheral surface on the upstream side of the insertion hole 29 of the center block 2, so that the upstream connection portion 60 is airtightly connected to the center block 2.

The upstream connection portion 60 is a member constituting a connection structure called one-touch fitting, pipe fitting, or the like, and can connect or disconnect the upstream external pipe 101 without one-touch operation, that is, without using a tool or the like. A configuration of the upstream connection portion 60 is not limited to the above-described configuration, and various fitting structures can be adopted. Further, a shape of the upstream connection portion 60 can also be freely set.

The downstream connection portion 61 is a member for connection with the downstream external pipe 102 so as to make a flow path of the downstream external pipe 102 and the downstream side of the flow path of the built-in pipe 13 communicate with each other. The downstream connection portion 61 is configured similarly to the upstream connection portion 60, and is configured such that the downstream connection portion 61 is airtightly connected to the center block 2 by screwing a screw thread 61a formed on an outer peripheral surface on the downstream side into a screw groove 29b formed on an inner peripheral surface on the downstream side of the insertion hole 29 of the center block 2. Note that the upstream connection portion 60 and the downstream connection portion 61 can be fixed to the center block 2 using a fixing structure other than screws.

The upstream pipeline member 62 is provided between the built-in pipe 13 and the upstream connection portion 60 and is a member that makes the flow path of the built-in pipe 13 and the flow path of the upstream external pipe 101 communicate with each other. Specifically, the upstream pipeline member 62 has a cylindrical shape and is held in a state of being inserted into the upstream side of the insertion hole 29 of the center block 2. The upstream side of the flow path of the upstream pipeline member 62 communicates with the flow path of the upstream connection portion 60, and the downstream side of the flow path of the upstream pipeline member 62 communicates with the flow path of the built-in pipe 13.

The downstream pipeline member 63 is provided between the built-in pipe 13 and the downstream connection portion 61 and is a member that makes the flow path of the built-in pipe 13 and the flow path of the downstream external pipe 102 communicate with each other. Specifically, the downstream pipeline member 63 has a cylindrical shape, and is held in a state of being inserted into the downstream side of the insertion hole 29 of the center block 2. The downstream side of the flow path of the downstream pipeline member 63 communicates with the flow path of the downstream connection portion 61, and the upstream side of the flow path of the downstream pipeline member 63 communicates with the flow path of the built-in pipe 13.

The pipe built-in type flowmeter 1A further includes a circuit board 65. The first ultrasonic element 11 and the second ultrasonic element 12 are connected to the circuit board 65. Furthermore, a pressure measuring element 66 for measuring the pressure of the working gas in the built-in pipe 13 is mounted on the circuit board 65.

In the upstream part of the center block 2, a tubular portion 22 into which a pressure receiving portion 66a of the pressure measuring element 66 is fitted is provided so as to protrude in a direction orthogonal to a pipe axis X of the built-in pipe 13. A sensor sealing member 23 made of an O-ring is provided between an inner surface of the tubular portion 22 and an outer surface of the pressure receiving portion 66a, and airtightness between the tubular portion 22 and the pressure receiving portion 66a is secured by the sensor sealing member 23.

Furthermore, a communication path 24 communicating with the flow path of the built-in pipe 13 is provided between the built-in pipe 13 and the upstream connection portion 60 in the upstream part of the center block 2. The communication path 24 includes a first channel 62b penetrating through a peripheral wall of the upstream pipeline member 62 and a second channel 2a communicating with the first channel 62b and extending to reach the pressure receiving portion 66a of the pressure measuring element 66. The first channel 62b communicates with a part between the upstream pipe sealing member 13a and the upstream connection portion 60 inside the insertion hole 29 of the center block 2. Further, the second channel 2a also communicates with a part between the upstream pipe sealing member 13a and the upstream connection portion 60 inside the insertion hole 29 of the center block 2. As a result, the flow path of the built-in pipe 13 communicates with the inside of the tubular portion 22 via the communication path 24, and the pressure receiving portion 66a of the pressure measuring element 66 is provided to face the communication path 24. Note that the pressure measuring element 66 may be provided on the downstream side of the built-in pipe 13 although not illustrated.

### Configuration of Control Unit

The control unit 7 is illustrated in FIG. 1. The control unit 7 to which the clamp-on flowmeter 1 illustrated in FIG. 4 is connected and the control unit 7 to which the pipe built-in type flowmeter 1A illustrated in FIG. 5 is connected may be the same or different. The first circuit board 51 and the second circuit board 52 of the clamp-on flowmeter 1 illustrated in FIG. 4 can be connected to the control unit 7 via the connection line 3. Further, the circuit board 65 of the pipe built-in type flowmeter 1A illustrated in FIG. 5 can be connected to the control unit 7 via the connection line 3.

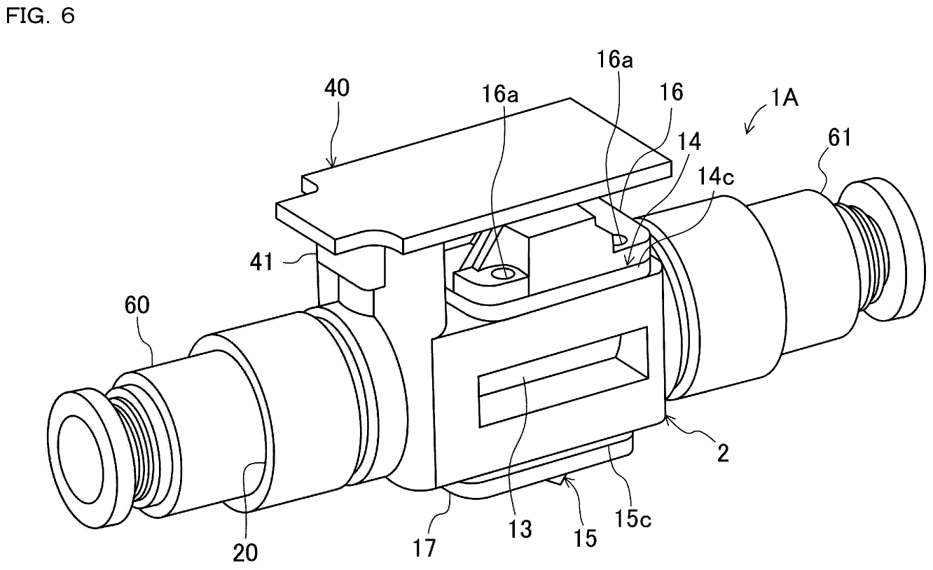

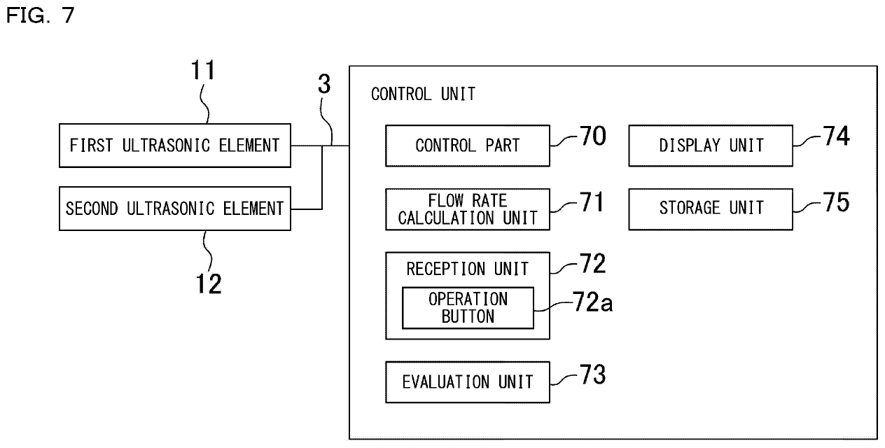

The control unit 7 includes a housing 7A having an elongated shape. Furthermore, as illustrated in FIG. 7, the control unit 7 includes a control part 70 that controls the first ultrasonic element 11 and the second ultrasonic element 12, a flow rate calculation unit 71 that calculates the flow rate of the working gas based on reception signals received from the ultrasonic elements 11 and 12, a reception unit 72 that receives various operations of a user, an evaluation unit 73 that evaluates operations of the pneumatic devices, a display unit 74 that displays various types of information, and a storage unit 75. The control part 70, the flow rate calculation unit 71, the reception unit 72, and the evaluation unit 73 include a microcomputer or the like that operates according to a program stored in advance in the storage unit 75 or the like. All of the control part 70, the flow rate calculation unit 71, the reception unit 72, and the evaluation unit 73 may be configured by the same microcomputer or the like, or may be configured by different microcomputers or the like.

The reception unit 72 includes an operation button 72a and the like in addition to the above-described microcomputer and the like. One or two or more operation buttons 72a may be provided, and the operation buttons 72a may include, for example, a first operation button for performing an operation of sequentially sending a plurality of options and menus, and a second operation button for performing an operation of determining a selected item. The operation button 72a is provided on an upper surface of the housing 7A as illustrated in FIG. 1.

The display unit 74 is configured using, for example, an organic EL display, a liquid crystal display, or the like, and is controlled by the control part 70. As illustrated in FIG. 1, the display unit 74 is also provided on the upper surface of the housing 7A, and has a shape elongated in the longitudinal direction of the housing 7A. Further, the storage unit 75 stores the above-described program, display screen information to be displayed on the display unit 74, and the like.

The first ultrasonic element 11 and the second ultrasonic element 12 controlled by the control part 70 transmit predetermined ultrasonic signals. Further, the ultrasonic signals received by the first ultrasonic element 11 and the second ultrasonic element 12 are transmitted to the flow rate calculation unit 71. The flow rate calculation unit 71 is a part that calculates a flow rate of a gas in the pipe 100 based on a propagation time difference of a longitudinal wave excited in the pipe 100 among the ultrasonic signals transmitted and received between the first ultrasonic element 11 and the second ultrasonic element 12. The flow rate calculation unit 71 can be configured by a flow rate calculation unit of a propagation time difference method, and the ultrasonic signals transmitted and received between the first ultrasonic element 11 and the second ultrasonic element 12 are input to the flow rate calculation unit 71.

As illustrated in FIG. 4, the first ultrasonic element 11 and the second ultrasonic element 12 are inclined with respect to the pipe axis X of the pipe 100, an ultrasonic wave obliquely passes through the working gas flowing in the pipe 100. The first ultrasonic element 11 transmits the ultrasonic signal in a direction opposite to the flow, and the second ultrasonic element 12 transmits the ultrasonic signal in a direction along the flow of the working gas. Since the ultrasonic signals are transmitted and detected in the direction along the flow of the working gas and the direction opposite to the flow, respectively, in this manner, a difference in the propagation time of the ultrasonic signal is generated between the direction along the flow of the working gas and the direction opposite to the flow.

Specifically, the first ultrasonic element 11 and the second ultrasonic element 12 are controlled by the control part 70 to intermittently emit a burst wave ultrasonic signal (a signal in which ultrasonic pulses of several MHz order form, for example, about 10 lumps). The flow rate calculation unit 71 samples a received waveform at a high speed by an A/D converter of the flow rate calculation unit 71. The flow rate calculation unit 71 aligns a forward reception waveform and a backward reception waveform with each time at a time point of emission as the origin, performs matching between waveform shapes while relatively shifting the waveforms in the time direction from the state, and determines a time shift amount at which the matching degree is maximum as a propagation time difference. The flow rate calculation unit 71 calculates a flow velocity and a flow rate from the determined propagation time difference. The flow rate calculated by the flow rate calculation unit 71 may be an instantaneous flow rate or an integrated flow rate obtained by integrating flow rates up to the current time.

The flow rate calculation unit 71 can also measure a mass flow rate by using the pressure measured by the pressure measuring element 66. When calculating the mass flow rate, a temperature sensor that measures a temperature of the working gas flowing through the flow path of the built-in pipe 13 illustrated in FIG. 5 may be provided to use the temperature of the working gas detected by the temperature sensor, or a sound velocity may be calculated based on the ultrasonic signals received by the first ultrasonic element 11 and the second ultrasonic element 12, and a temperature may be estimated from the calculated sound velocity and used for calculating the mass flow rate.

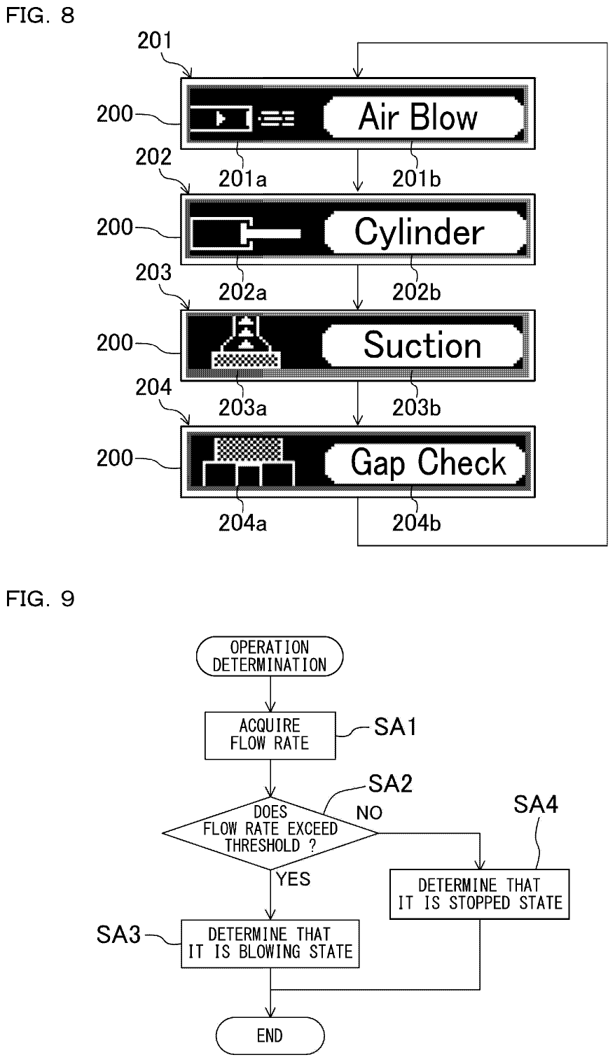

The reception unit 72 is a part that receives selection of a type of the pneumatic device connected to the pipe 100 from the user. Specifically, at the time of setting before starting the operation of the flow sensor A, the control part 70 generates an application selection screen 200 as illustrated in FIG. 8 and displays the generated screen on the display unit 74. The application selection screen 200 is a screen for the user to select the pneumatic device to be evaluated by the evaluation unit 73. As indicated by arrows in FIG. 8, when the operation button 72a is operated, an air blow selection screen 201, an air cylinder selection screen 202, a suction conveyance selection screen 203, and a seating selection screen 204 are sequentially displayed on the application selection screen 200. The displayed order and number are not limited thereto.

The air blow selection screen 201 displays a diagram display region 201a in which a diagram schematically illustrating the air blowing device is displayed and a character display region 201b in which characters indicating the air blowing device are displayed. Further, the air cylinder selection screen 202 displays a diagram display region 202a in which a diagram schematically illustrating the air cylinder device is displayed and a character display region 202b in which characters indicating the air cylinder device are displayed. Further, the suction conveyance selection screen 203 displays a diagram display region 203a in which a diagram schematically illustrating the suction conveying device is displayed and a character display region 203b in which characters indicating the suction conveying device are displayed. Further, the seating selection screen 204 displays a diagram display region 204a in which a diagram schematically illustrating the seating device is displayed and a character display region 204b in which characters indicating the seating device are displayed. When the user performs a sending operation with the operation button 72a until the pneumatic device connected to the pipe 100 is displayed on the application selection screen 200 and performs a determining operation with the operation button 72a in a state where the pneumatic device connected to the pipe 100 is displayed on the application selection screen 200, the pneumatic device displayed on the application selection screen 200 is selected and received by the reception unit 72.

### Configuration of Evaluation Unit

The evaluation unit 73 is a part that determines a characteristic amount indicating an operation of the pneumatic device based on a combination of the flow rate measured by the first ultrasonic element 11 and the second ultrasonic element 12 and the pressure measured by the pressure measuring element 66, and evaluates the operation of the pneumatic device to which the pipe 100 is connected based on the characteristic amount. When determining the characteristic amount, the evaluation unit 73 determines the characteristic amount corresponding to a type of the pneumatic device connected to the pipe 100. The type of the pneumatic device connected to the pipe 100 can be the type of the pneumatic device received by the reception unit 72, and thus, the evaluation unit 73 determines the characteristic amount according to the type of the pneumatic device received by the reception unit 72.

Hereinafter, description will be given in detail for each of the pneumatic devices connected to the pipe 100. First, a case where the air blowing device is connected to the pipe 100 will be described. Whether the air blowing device connected to the pipe 100 is in an operating state (blowing state) or a stopped state (non-blowing state) is determined based on the flow rate of the working gas in the pipe 100. FIG. 9 is a flowchart illustrating a procedure of processing for determining the operating state of the air blowing device. In Step SA1, the evaluation unit 73 acquires a flow rate of the working gas calculated by the flow rate calculation unit 71. Note that the evaluation unit 73 may calculate and acquire the flow rate of the working gas.

Thereafter, in Step SA2, it is determined whether or not the flow rate acquired in Step SA1 exceeds a predetermined threshold. In a case where the flow rate acquired in Step SA1 exceeds the predetermined threshold, it is estimated that the flow rate of the working gas is large and the working gas is being used for blowing. Thus, the processing proceeds to Step SA3 to determine that the air blowing device is in the blowing state, and then, ends. On the other hand, in a case where the flow rate acquired in Step SA1 is equal to or less than the predetermined threshold, the processing proceeds to Step SA4 to determine that the air blowing device is in the stopped state, and then, ends. That is, the predetermined threshold is a threshold with which it can be determined whether or not the working gas is being used for blowing.

Further, the evaluation unit 73 executes reference value determination processing of determining evaluation reference values to serve as references for evaluating an operation of the air blowing device. The evaluation reference values are determined using a plurality of flow rates measured by the first ultrasonic element 11 and the second ultrasonic element 12 and a plurality of pressures measured by the pressure measuring element 66 when the air blowing device repeats the operation in response to an input of a trigger signal from the outside. Specifically, the control unit 7 receives the trigger signal for operating the air blowing device, and the reference value determination processing is repeatedly executed, with a timing at which the trigger signal is received as a start timing, using flow rates and pressures acquired at a plurality of different timings until a degree of reliability of the evaluation reference values is equal to or higher than a predetermined degree of reliability. For example, the blowing state of the air blowing device can be detected by receiving the trigger signal, and the flow rate and the pressure of the working gas when the air blowing device is in the blowing state are measured and stored. As this processing is repeated a plurality of times, the flow rate and the pressure of the working gas when the air blowing device is in the blowing state are almost fixed, and a flow rate and a pressure at a time point when fluctuations decrease even after the number of times of the repetition are set as the evaluation reference values. The evaluation reference values are stored in the storage unit 75 and used as internal values. Note that the number of times of repeated execution is traded off with a response time, and thus, the number of times may be changed on the user side.

The reference value determination processing can also be called learning processing or teaching processing. After being completed once, the reference value determination processing can be executed again by a re-execution instruction from the user. Further, the reference value determination processing can be stopped by a stop instruction from the user.

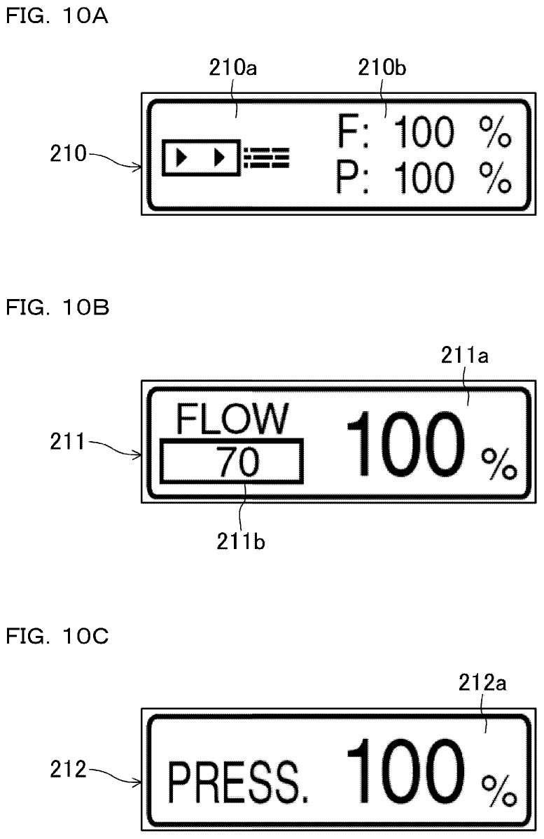

The evaluation reference values serve as references when display values of the flow rate and the pressure to be displayed on the display unit 74 are set to 100%. That is, as illustrated in FIG. 10A of FIG. 10, the control part 70 generates a measurement value display screen 210 for the air blowing device and displays the generated screen on the display unit 74. The measurement value display screen 210 is provided with a diagram display region 210a in which a diagram schematically illustrating the air blowing device is displayed, and a measurement value display region 210b in which a flow rate indicated by “F” and a pressure indicated by “P” are individually displayed. The flow rate and the pressure displayed on the measurement value display screen 210 are the display values, and the evaluation reference values are used as the references when the display values are set to 100%.

FIG. 10B is a flow rate threshold setting screen 211. When the user performs a threshold setting operation, the control part 70 generates the flow rate threshold setting screen 211 and displays the generated screen on the display unit 74. The flow rate threshold setting screen 211 is provided with a flow rate display region 211a in which the display value of the flow rate displayed in the measurement value display region 210b illustrated in FIG. 10A is displayed, and a threshold display region 211b in which a threshold for performing evaluation is displayed.

FIG. 10C is a flow rate threshold setting screen 212. When the user performs a threshold setting operation, the control part 70 generates a pressure threshold setting screen 212 and displays the generated screen on the display unit 74. The pressure threshold setting screen 212 is provided with a pressure display region 212a in which the display value of the pressure displayed in the measurement value display region 210b illustrated in FIG. 10A is displayed.

In a case where the air blowing device is connected to the pipe 100, the evaluation unit 73 determines a characteristic amount indicating an operation of the air blowing device as a blowing amount, which is a mass flow rate of the compressed air ejected from the nozzle of the air blowing device, and evaluates the operation of the air blowing device based on the blowing amount. When being determined by the evaluation unit 73, the characteristic amount is determined based on a combination of time-series data of the flow rate and time-series data of the pressure.

For example, the evaluation unit 73 evaluates that the clogging of the nozzle of the air blowing device occurs in a case where the blowing amount is equal to or less than a predetermined blowing amount and the pressure measured by the pressure measuring element 66 is equal to or more than a reference pressure, and evaluates that the pressure drop of the compressed air supplied to the air blowing device occurs in a case where the blowing amount is equal to or less than the predetermined blowing amount and the pressure measured by the pressure measuring element 66 is less than the reference pressure. The pressure drop of the compressed air supplied to the air blowing device is referred to as an original pressure drop.

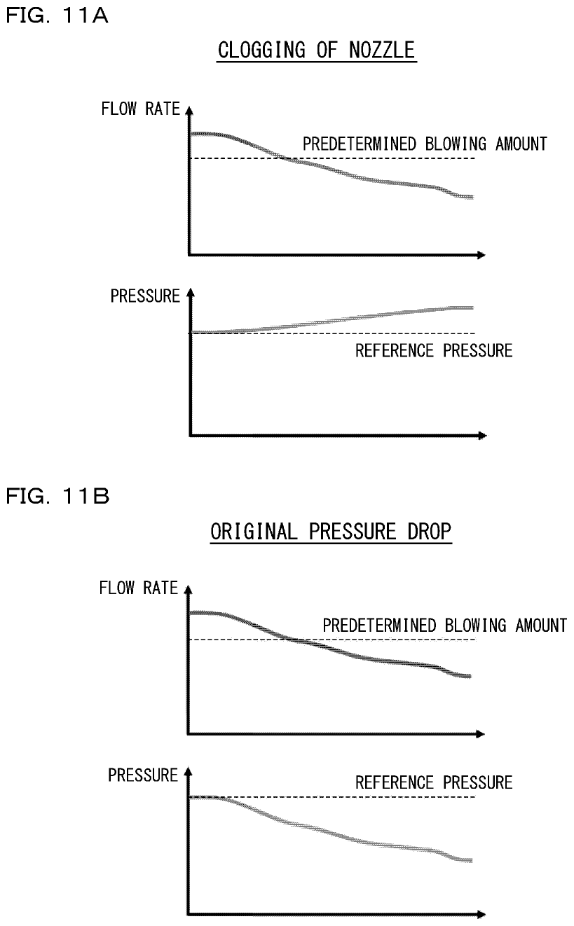

The evaluation of the operation of the air blowing device by the evaluation unit 73 will be described more specifically with reference to FIGS. 11A and 11B. FIG. 11A of FIG. 11 is a graph for describing a case of evaluating clogging of the nozzle of the air blowing device, and the upper graph illustrates time-series data of the flow rate with the vertical axis representing the flow rate and the horizontal axis representing time. The lower graph illustrates time-series data of the pressure with the vertical axis representing the pressure and the horizontal axis representing time. When the nozzle of the air blowing device is clogged, the flow rate of the working gas decreases to be equal to or less than the predetermined blowing amount (indicated by a broken line) as illustrated in the upper graph, but the pressure does not change or increases with respect to the reference pressure (indicated by a broken line) as illustrated in the lower graph. Therefore, the clogging of the nozzle of the air blowing device can be accurately evaluated based on both the flow rate and the pressure.

FIG. 11B is a graph for describing a case of evaluating an original pressure, and the upper graph illustrates time-series data of the flow rate with the vertical axis representing the flow rate and the horizontal axis representing time. The lower graph illustrates time-series data of the pressure with the vertical axis representing the pressure and the horizontal axis representing time. When the original pressure drop of the air blowing device occurs, the flow rate of the working gas decreases to be equal to or less than the predetermined blowing amount (indicated by a broken line) as illustrated in the upper graph, and the pressure is less than the reference pressure (indicated by a broken line) as illustrated in the lower graph. Therefore, it is possible to accurately evaluate the original pressure drop of the air blowing device based on both the flow rate and the pressure.

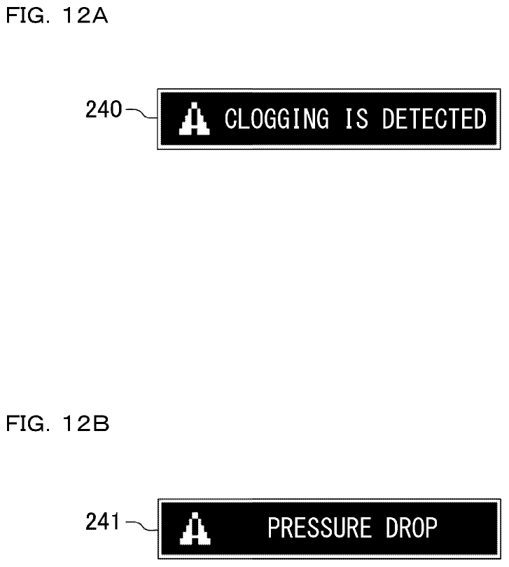

When the evaluation unit 73 evaluates that the clogging of the nozzle of the air blowing device occurs, the control part 70 generates an alarm screen 220 indicating that the clogging of the nozzle occurs and displays the generated screen on the display unit 74 as illustrated in FIG. 12A of FIG. 12. When the evaluation unit 73 evaluates that the original pressure drop of the air blowing device occurs, the control part 70 generates an alarm screen 221 indicating that the original pressure drop occurs and displays the generated screen on the display unit 74 as illustrated in FIG. 12B of FIG. 12.

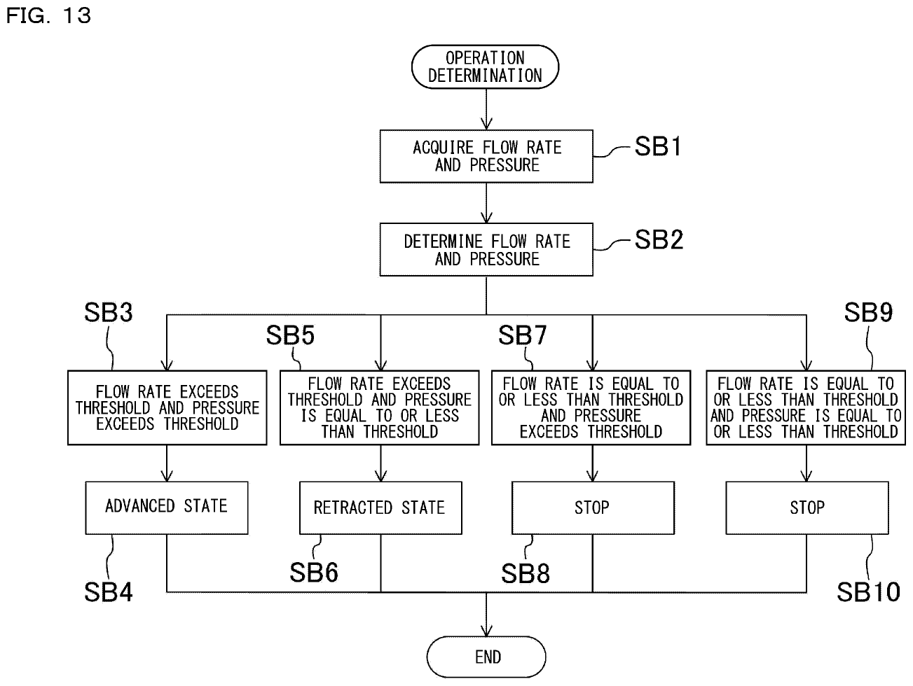

Next, a case where the air cylinder device is connected to the pipe 100 will be described. Whether the rod of the air cylinder device connected to the pipe 100 is in an advanced state, a retracted state, or a stopped state is determined based on the flow rate and the pressure of the working gas. FIG. 13 is a flowchart illustrating a procedure of processing for determining an operating state of the air cylinder device. In Step SB1, the evaluation unit 73 acquires a flow rate of the working gas calculated by the flow rate calculation unit 71 and a pressure. The evaluation unit 73 may calculate and acquire the flow rate and the pressure.

In Step SB2, it is determined whether or not the flow rate and the pressure acquired in Step SB1 exceed a flow rate determination threshold and a pressure determination threshold, respectively. In a case where the flow rate exceeds the flow rate determination threshold and the pressure exceeds the pressure determination threshold (in the case of Step SB3), the processing proceeds to Step SB4 to determine that the air cylinder device is in the advanced state, and then, ends. In a case where the flow rate exceeds the flow rate determination threshold and the pressure is equal to or less than the pressure determination threshold (in the case of Step SB5), the processing proceeds to Step SB6 to determine that the air cylinder device is in the retracted state, and then, ends. In a case where the flow rate is equal to or less than the flow rate determination threshold and the pressure exceeds the pressure determination threshold (in the case of Step SB7), the processing proceeds to Step SB8 to determine that the air cylinder device is in the stopped state, and then, ends. In a case where the flow rate is equal to or less than the flow rate determination threshold and the pressure is equal to or less than the pressure determination threshold (in the case of Step SB9), the processing proceeds to Step SB10 to determine that the air cylinder device is in the stopped state, and then, ends.

Further, the evaluation unit 73 executes reference value determination processing of determining evaluation reference values to serve as references for evaluating an operation of the air cylinder device. The evaluation reference values are determined using a plurality of flow rates and pressures measured by the first ultrasonic element 11 and the second ultrasonic element 12, and the pressure measuring element 66, respectively, when the air cylinder device repeats the operation. Specifically, the control unit 7 receives the trigger signal at the time of operating the air cylinder device, and the reference value determination processing is repeatedly executed, with a timing at which the trigger signal is received as a start timing, using flow rates and pressures acquired at a plurality of different timings until a degree of reliability of the evaluation reference value is equal to or higher than a predetermined degree of reliability. For example, whether the air cylinder device is in the advanced state, the retracted state, or the stopped state can be detected by receiving the trigger signal, and the flow rate and the pressure of the working gas are measured and stored for each of the advanced state, the retracted state, and the stopped state of the air cylinder device. As this processing is repeated a plurality of times, the flow rate and the pressure of the working gas when the air cylinder device is in each of the advanced state, the retracted state, and the stopped state are almost fixed, and a flow rate and a pressure at a time point when fluctuations decrease even after the number of times of the repetition are set as the respective evaluation reference values. The respective evaluation reference values are stored in the storage unit 75 and used as internal values.

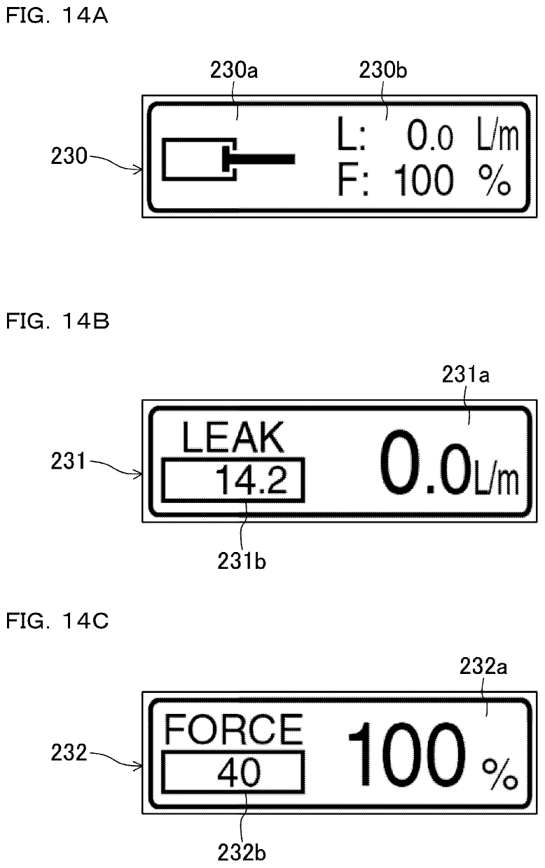

The evaluation reference values serve as references when display values of the flow rate and the pressure to be displayed on the display unit 74 are set to 100%. That is, as illustrated in FIG. 14A of FIG. 14, the control part 70 generates a measurement value display screen 230 for the air cylinder device and displays the generated screen on the display unit 74. The measurement value display screen 230 is provided with a diagram display region 230a in which a diagram schematically illustrating the air cylinder device is displayed, and a measurement value display region 230b in which a leakage amount indicated by “L” and a thrust margin indicated by “F” are individually displayed. The leakage amount and the thrust margin displayed on the measurement value display screen 230 are the display values, and the evaluation reference values are used as the references when the display value of the thrust margin is set to 100%.

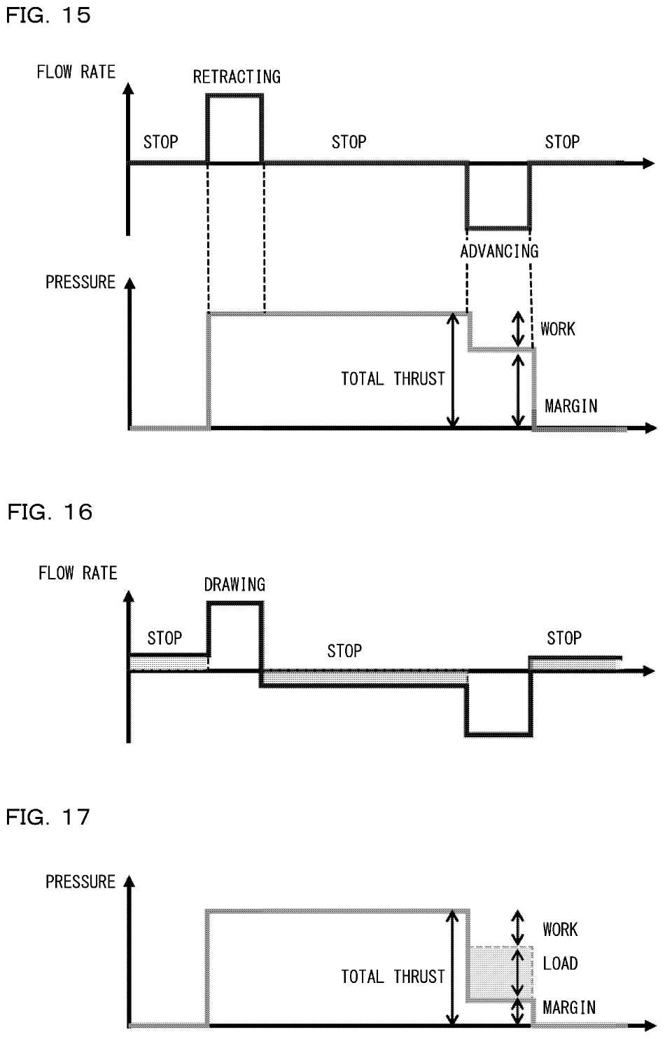

Here, the leakage amount and the thrust margin of the air cylinder device will be described. First, a relationship between the operation of the air cylinder device and the flow rate and the pressure of the working gas will be described with reference to FIG. 15. The rod can be retracted by supplying a predetermined amount of the working gas to the air cylinder device, and the rod can be advanced by discharging a predetermined amount of the working gas from the air cylinder device. In the case of an ideal air cylinder device having no leakage of the working gas, a flow rate of the working gas becomes zero when the rod is in the stopped state. However, as illustrated in FIG. 16, when the working gas leaks due to deterioration of packing of the air cylinder device or the like, the flow rate does not become zero even though the rod is in the stopped state. That is, the leakage amount is the flow rate of the working fluid when the air cylinder device is in the stopped state, and the leakage amount increases when the packing of the air cylinder device is deteriorated. Note that it is difficult to manufacture an air cylinder device in which a leakage amount is zero, and thus, a slight leakage occurs even in a new air cylinder device, and a threshold is set in consideration of this.

Further, as illustrated in the lower view (a graph illustrating a pressure change) of FIG. 15, the total thrust is determined by the pressure of the working gas in the case of the air cylinder device. If a part of the total thrust is used for work, the remaining thrust is the thrust margin. The thrust margin can be obtained by a ratio between a pressure at the time of advancement and a pressure at the time of stop. As illustrated in FIG. 17, the thrust margin decreases when the load increases. The load may increase due to, for example, bending of the rod or the like.

FIG. 14B of FIG. 14 is a leakage amount threshold setting screen 231. When the user performs a threshold setting operation, the control part 70 generates the leakage amount threshold setting screen 231 and displays the generated screen on the display unit 74. The leakage amount threshold setting screen 231 is provided with a leakage amount display region 231a in which the display value of the leakage amount displayed in the measurement value display region 230b illustrated in FIG. 14A is displayed, and a threshold display region 231b in which a threshold for performing evaluation is displayed.

FIG. 14C is a thrust margin threshold setting screen 232. When the user performs a threshold setting operation, the control part 70 generates the thrust margin threshold setting screen 232 and displays the generated screen on the display unit 74. The thrust margin threshold setting screen 232 is provided with a thrust margin display region 232a in which the display value of the thrust margin displayed in the measurement value display region 230b illustrated in

FIG. 14A is displayed, and a threshold display region 232b in which a threshold for performing evaluation is displayed.

In a case where the air cylinder device is connected to the pipe 100, the evaluation unit 73 determines characteristic amounts indicating an operation of the air cylinder device as a leakage amount of the air cylinder device and a thrust margin of the air cylinder device, and evaluates the operation of the air cylinder device based on the leakage amount and the thrust margin. For example, in a case where a leakage amount when the air cylinder device is stopped is equal to or more than a predetermined leakage amount, the evaluation unit 73 evaluates that the deterioration of the packing of the air cylinder device occurs. Further, when the thrust margin of the air cylinder device is less than a predetermined value, the evaluation unit 73 evaluates that the thrust margin has decreased.

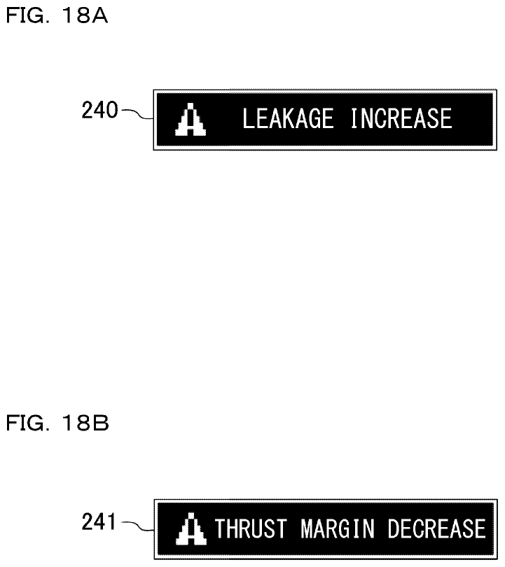

When the evaluation unit 73 evaluates that the packing of the air cylinder device is being deteriorated (the leakage amount is increasing), the control part 70 generates an alarm screen 240 indicating that the leakage amount is increasing and displays the generated screen on the display unit 74 as illustrated in FIG. 18A of FIG. 18. When the evaluation unit 73 evaluates that the thrust margin of the air cylinder device has decreased, the control part 70 generates an alarm screen 241 indicating that the thrust margin has decreased and displays the generated screen on the display unit 74 as illustrated in FIG. 18B of FIG. 18.

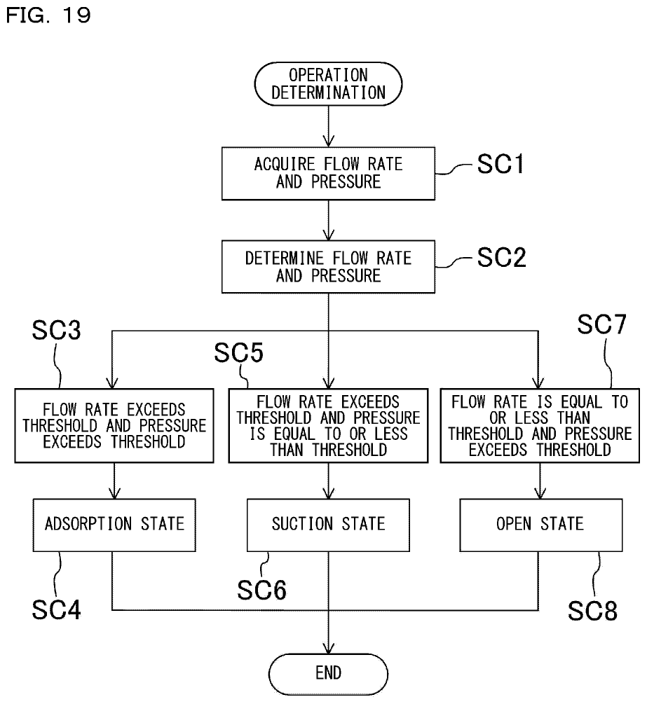

Next, a case where the suction conveying device is connected to the pipe 100 will be described. Whether the suction conveying device connected to the pipe 100 is in a suction state, an adsorption state, or an open state is determined based on the flow rate and the pressure of the working gas. FIG. 19 is a flowchart illustrating a procedure of processing for determining an operating state of the suction conveying device. In Step SC1, the evaluation unit 73 acquires a flow rate and a pressure of the working gas calculated by the flow rate calculation unit 71. In Step SC2, it is determined whether or not the flow rate and the pressure acquired in Step SC1 exceed a flow rate determination threshold and a pressure determination threshold, respectively. In a case where the flow rate exceeds the flow rate determination threshold and the pressure exceeds the pressure determination threshold (in the case of Step SC3), the processing proceeds to Step SC4 to determine that the suction conveying device is in the adsorption state, and then, ends. In a case where the flow rate exceeds the flow rate determination threshold and the pressure is equal to or less than the pressure determination threshold (in the case of Step SC5), the processing proceeds to Step SC6 to determine that the suction conveying device is in the suction state, and then, ends. In a case where the flow rate is equal to or less than the flow rate determination threshold and the pressure exceeds the pressure determination threshold (in the case of Step SC7), the processing proceeds to Step SC8 to determine that the suction conveying device is in the open state, and then, ends.

Further, the evaluation unit 73 executes reference value determination processing of determining evaluation reference values to serve as references for evaluating an operation of the suction conveying device. The evaluation reference values are determined using a plurality of flow rates and pressures measured by the first ultrasonic element 11 and the second ultrasonic element 12, and the pressure measuring element 66, respectively, when the suction conveying device repeats the operation. Specifically, the control unit 7 receives the trigger signal for operating the suction conveying device, and the reference value determination processing is repeatedly executed, with a timing at which the trigger signal is received as a start timing, using flow rates and pressures acquired at a plurality of different timings until a degree of reliability of the evaluation reference values is equal to or higher than a predetermined degree of reliability. For example, whether the suction conveying device is in the suction state, the adsorption state, or the open state can be detected by receiving the trigger signal, and the flow rate and the pressure of the working gas are measured and stored for each of the suction state, the adsorption state, and the open state of the suction conveying device. As this processing is repeated a plurality of times, the flow rate and the pressure of the working gas when the suction conveying device is in each of the suction state, the adsorption state, and the open state are almost fixed, and a flow rate and a pressure at a time point when fluctuations decrease even after the number of times of the repetition are set as the respective evaluation reference values. The respective evaluation reference values are stored in the storage unit 75 and used as internal values.

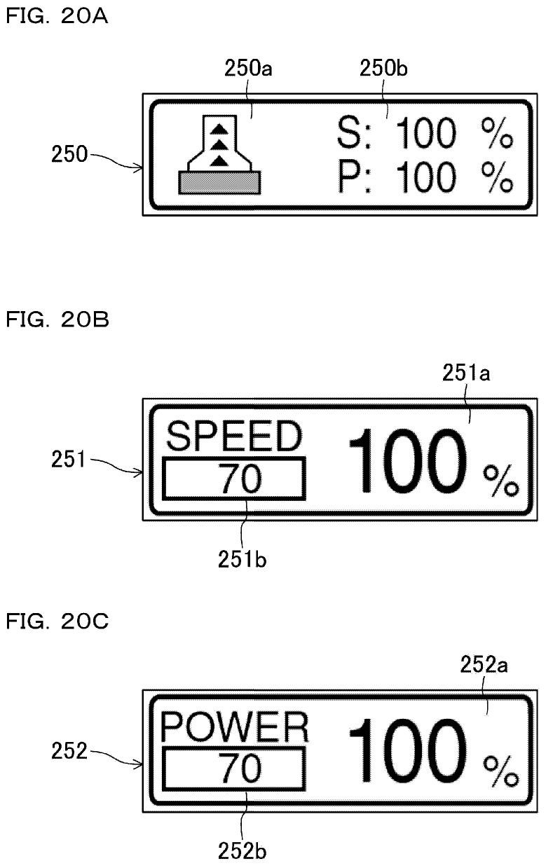

The evaluation reference values serve as references when display values of the flow rate and the pressure to be displayed on the display unit 74 are set to 100%. That is, as illustrated in FIG. 20A of FIG. 20, the control part 70 generates a measurement value display screen 250 for the suction conveying device and displays the generated screen on the display unit 74. The measurement value display screen 250 is provided with a diagram display region 250a in which a diagram schematically illustrating the suction conveying device is displayed, and a measurement value display region 250b in which a suction speed indicated by “S” and a suction force indicated by “P” are individually displayed. The suction speed and the suction force displayed on the measurement value display screen 250 are the display values, and the evaluation reference values are used as the references when these display values are set to 100%.

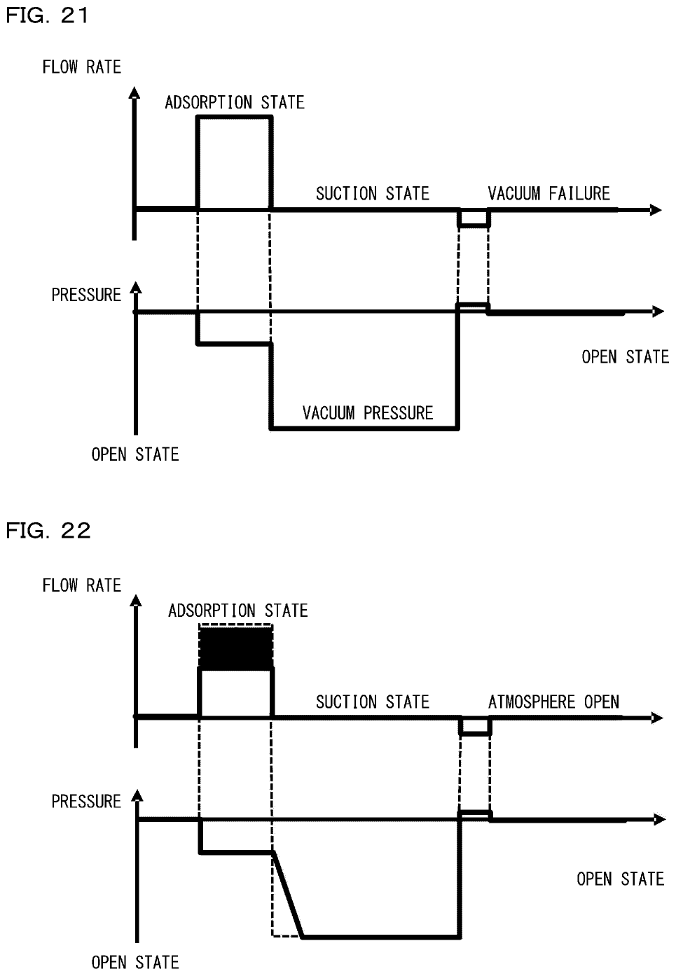

Here, a relationship between the operation of the suction conveying device and the flow rate and the pressure of the working gas will be described with reference to FIG. 21. The flow rate of the working gas is large during adsorption. When the workpiece is sucked, the flow rate of the working gas becomes zero, and the pressure becomes a vacuum pressure. When a vacuum failure occurs, the flow rate changes.

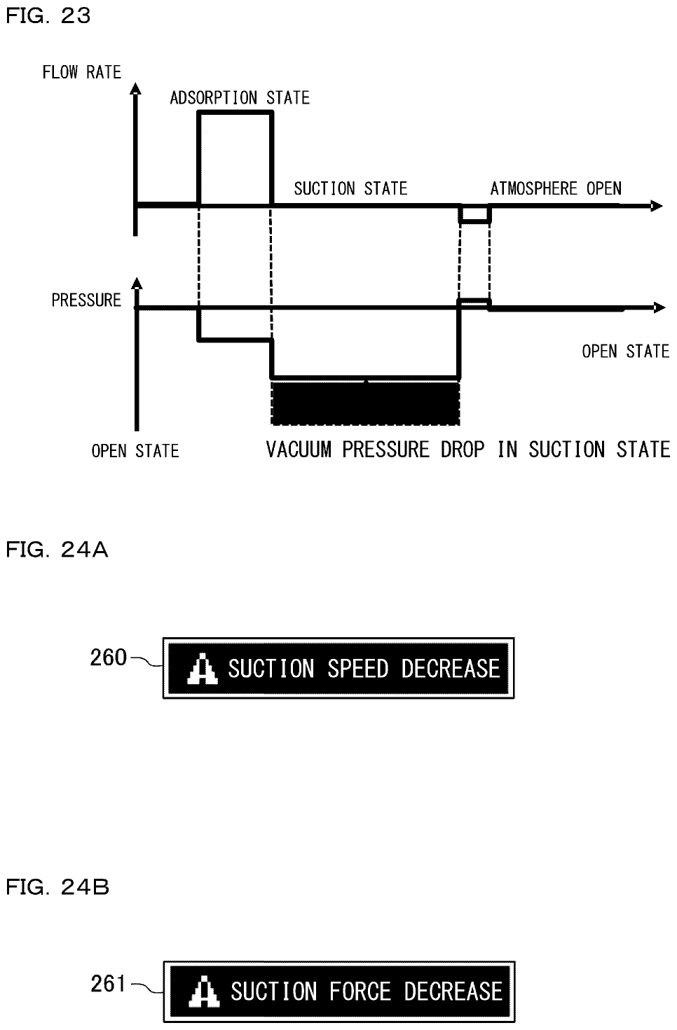

As illustrated in FIG. 22, when a filter included in the suction conveying device is clogged, the flow rate during the adsorption decreases, and a decrease in the pressure at the time of transitioning to the suction state becomes gentle. Further, as illustrated in FIG. 23, when the suction pad included in the suction conveying device is deteriorated, the vacuum pressure at the time of sucking the workpiece or the like decreases.

FIG. 20B of FIG. 20 illustrates a suction speed threshold setting screen 251. When the user performs a threshold setting operation, the control part 70 generates the suction speed threshold setting screen 251 and displays the generated screen on the display unit 74. The suction speed threshold setting screen 251 is provided with a suction speed display region 251a in which the display value of the suction speed displayed in the measurement value display region 250b illustrated in FIG. 20A is displayed, and a threshold display region 251b in which a threshold for performing evaluation is displayed.

FIG. 20C illustrates a suction force threshold setting screen 252. When the user performs a threshold setting operation, the control part 70 generates the suction force threshold setting screen 252 and displays the generated screen on the display unit 74. The suction force threshold setting screen 252 is provided with a suction force display region 252a in which the display value of the suction force displayed in the measurement value display region 250b illustrated in FIG. 20A is displayed, and a threshold display region 252b in which a threshold for performing evaluation is displayed.

In a case where the suction conveying device is connected to the pipe 100, the evaluation unit 73 determines characteristic amounts indicating an operation of the suction conveying device as a suction speed and a suction force, and evaluates the operation of the suction conveying device based on the suction speed and the suction force. For example, in a case where the flow rate during suction is equal to or less than a predetermined flow rate, the evaluation unit 73 evaluates that a pressure drop of the compressed air supplied to the suction conveying device or clogging of a flow path (clogging of the filter) of the suction conveying device occurs. Further, in a case where the suction force during suction is equal to or less than a predetermined force, the evaluation unit 73 evaluates that deterioration of the suction pad included in the suction conveying device occurs.

When the evaluation unit 73 evaluates that the clogging of the filter of the suction conveying device occurs, the control part 70 generates an alarm screen 260 indicating a decrease in the suction speed and displays the generated screen on the display unit 74 as illustrated in FIG. 24A of FIG. 24. When the evaluation unit 73 evaluates that the suction pad of the suction conveying device has deteriorated, the control part 70 generates an alarm screen 261 indicating that the suction force has decreased and displays the generated screen on the display unit 74 as illustrated in FIG. 24B of FIG. 24.

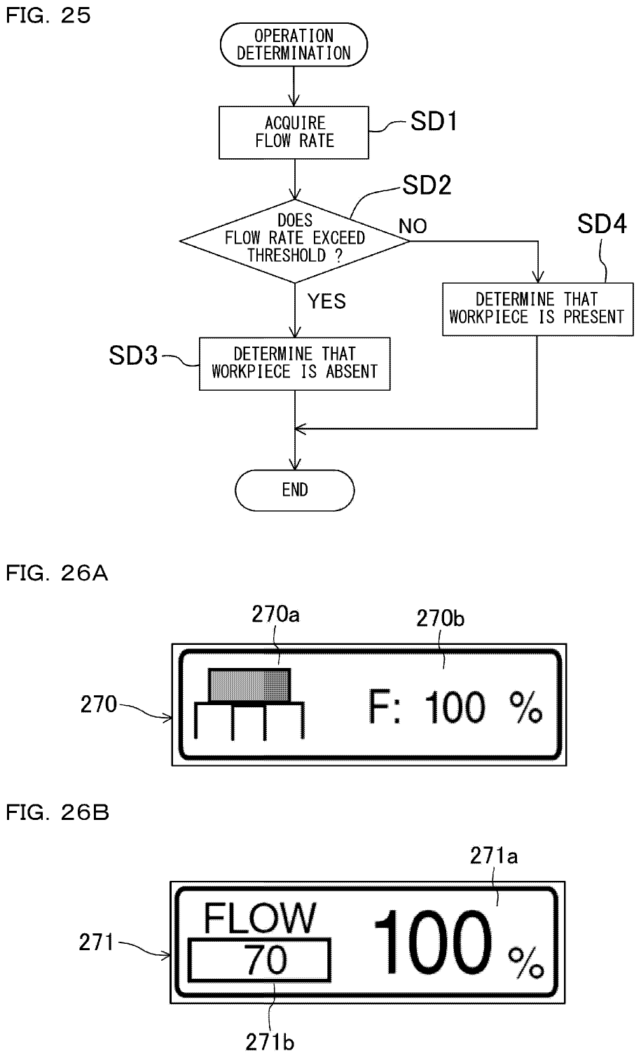

Next, a case where the seating device is connected to the pipe 100 will be described. Whether the seating device connected to the pipe 100 is in a state where a workpiece is absent (workpiece is not seated) or a state where a workpiece is present (workpiece is seated) is determined based on the flow rate of the working gas. FIG. 25 is a flowchart illustrating a procedure of processing for determining an operating state of the seating device. In Step SD1, the evaluation unit 73 acquires a flow rate of the working gas calculated by the flow rate calculation unit 71. In Step SD2, it is determined whether or not the flow rate acquired in Step SD1 exceeds a predetermined threshold. In a case where the flow rate acquired in Step SD1 exceeds the predetermined threshold, the flow rate of the working gas is large and it is estimated that the workpiece is not seated. Thus, the processing proceeds to Step SD3 to determine that it is the state where a workpiece is absent, and then, ends. On the other hand, in a case where the flow rate acquired in Step SD1 is equal to or less than the predetermined threshold, the processing proceeds to Step SD4 to determine that it is the state where a workpiece is present, and then, ends.

The evaluation unit 73 executes reference value determination processing of determining evaluation reference values to serve as references for evaluating an operation of the seating device. The evaluation reference values are determined using a plurality of flow rates and pressures measured by the first ultrasonic element 11 and the second ultrasonic element 12, and the pressure measuring element 66, respectively, when the seating device repeats the operation. Specifically, the control unit 7 receives the trigger signal for operating the seating device, and the reference value determination processing is repeatedly executed, with a timing at which the trigger signal is received as a start timing, using flow rates and pressures acquired at a plurality of different timings until a degree of reliability of the evaluation reference values is equal to or higher than a predetermined degree of reliability. The evaluation reference values are stored in the storage unit 75 and used as internal values.

The evaluation reference values serve as references when a display value of the flow rate to be displayed on the display unit 74 is set to 100%. That is, as illustrated in FIG. 26A of FIG. 26, the control part 70 generates a measurement value display screen 270 for the seating device and displays the generated screen on the display unit 74. The measurement value display screen 270 is provided with a diagram display region 270a in which a diagram schematically illustrating the seating device is displayed, and a measurement value display region 270b in which a flow rate indicated by “F” is displayed. The flow rate displayed on the measurement value display screen 270 is the display value, and the evaluation reference values are used as the references when the display value is set to 100%.

FIG. 26B is a flow rate threshold setting screen 271. When the user performs a threshold setting operation, the control part 70 generates the flow rate threshold setting screen 271 and displays the generated screen on the display unit 74. The flow rate threshold setting screen 271 is provided with a flow rate display region 271a in which the display value of the flow rate displayed in the measurement value display region 270b illustrated in FIG. 26A is displayed, and a threshold display region 271b in which a threshold for performing evaluation is displayed.

In a case where the seating device is connected to the pipe 100, the evaluation unit 73 determines a characteristic amount indicating an operation of the seating device as a volume flow rate of the compressed air ejected from the seating device, and evaluates the operation of the seating device based on the volume flow rate. For example, the evaluation unit 73 evaluates that clogging of a nozzle of the seating device occurs in a case where the volume flow rate in the state where a workpiece is absent is equal to or less than a predetermined flow rate and the pressure is within a predetermined range, and evaluates that a pressure drop (original pressure drop) of the compressed air supplied to the seating device occurs in a case where the volume flow rate in the state where a workpiece is absent is equal to or less than the predetermined flow rate and the pressure drops below the predetermined range.

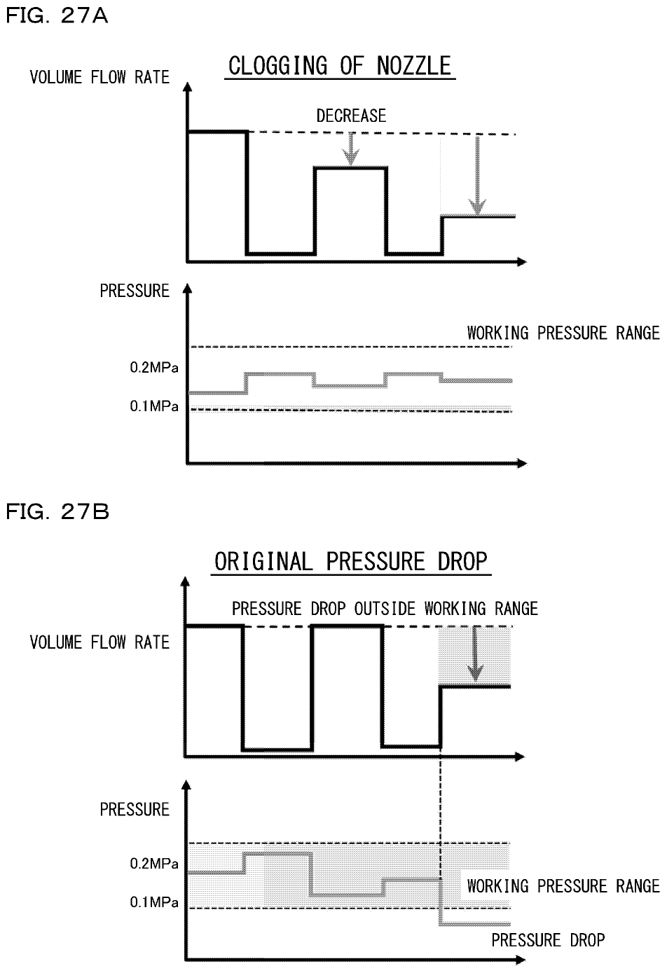

The evaluation of the operation of the seating device by the evaluation unit 73 will be described more specifically with reference to FIGS. 27A and 27B. FIG. 27A of FIG. 27 is a graph for describing a case of evaluating clogging of the nozzle of the seating device, and the upper graph illustrates time-series data of the volume flow rate with the vertical axis representing the volume flow rate and the horizontal axis representing time. The lower graph illustrates time-series data of the pressure with the vertical axis representing the pressure and the horizontal axis representing time. When the nozzle of the seating device is clogged, the volume flow rate of the working gas decreases to be equal to or less than the predetermined flow rate (indicated by a broken line) as illustrated in the upper graph, but the pressure is within a working pressure range (indicated by a broken line) as illustrated in the lower graph. Therefore, the clogging of the nozzle of the seating device can be accurately evaluated based on both the volume flow rate and the pressure.

FIG. 27B is a graph for describing a case of evaluating an original pressure, and the upper graph illustrates time-series data of the volume flow rate with the vertical axis representing the volume flow rate and the horizontal axis representing time. The lower graph illustrates time-series data of the pressure with the vertical axis representing the pressure and the horizontal axis representing time. When the original pressure drop of the seating device occurs, the volume flow rate of the working gas decreases to be equal to or less than the predetermined flow rate (indicated by a broken line) as illustrated in the upper graph, and the pressure is less than the working pressure range (indicated by a broken line) as illustrated in the lower graph. Therefore, the original pressure drop of the seating device can be accurately evaluated based on both the volume flow rate and the pressure. Further, separately from this evaluation criterion, the evaluation unit 73 evaluates that the pressure drop occurs when the pressure falls below a predetermined minimum pressure (for example, around 0.1 MPa).

When the evaluation unit 73 evaluates that the clogging of the nozzle of the seating device occurs, the control part 70 generates an alarm screen 220 indicating that the clogging of the nozzle occurs and displays the generated screen on the display unit 74 as illustrated in FIG. 12A of FIG. 12. When the evaluation unit 73 evaluates that the original pressure drop of the seating device occurs, the control part 70 generates an alarm screen 221 indicating that the original pressure drop occurs and displays the generated screen on the display unit 74 as illustrated in FIG. 12B of FIG. 12.

### Trend Monitoring Function

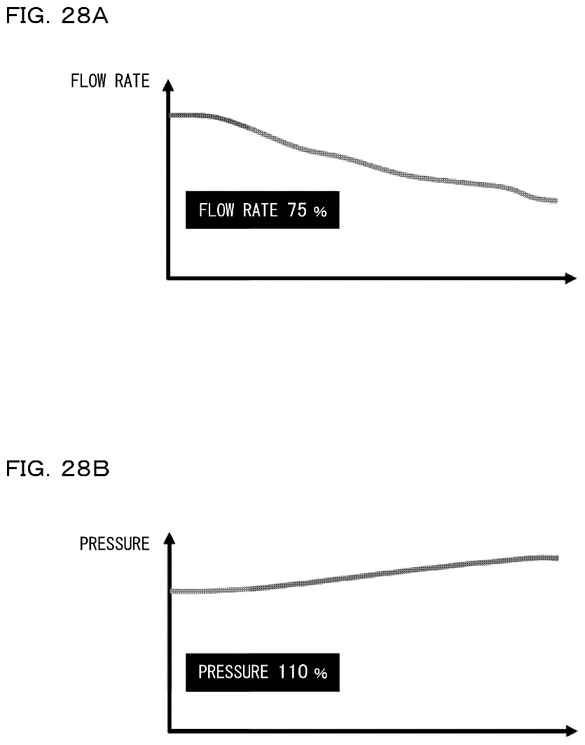

The flow sensor A also has a trend monitoring function of monitoring time-series changes in the flow rate and the pressure. When the flow rate has changed, a flow rate at a current time point can be displayed on the display unit 74 as a percentage to the evaluation reference value as illustrated in FIG. 28A of FIG. 28. Further, when the pressure has changed, a pressure at a current time point can be similarly displayed on the display unit 74 as a percentage to the evaluation reference value as illustrated in FIG. 28B.

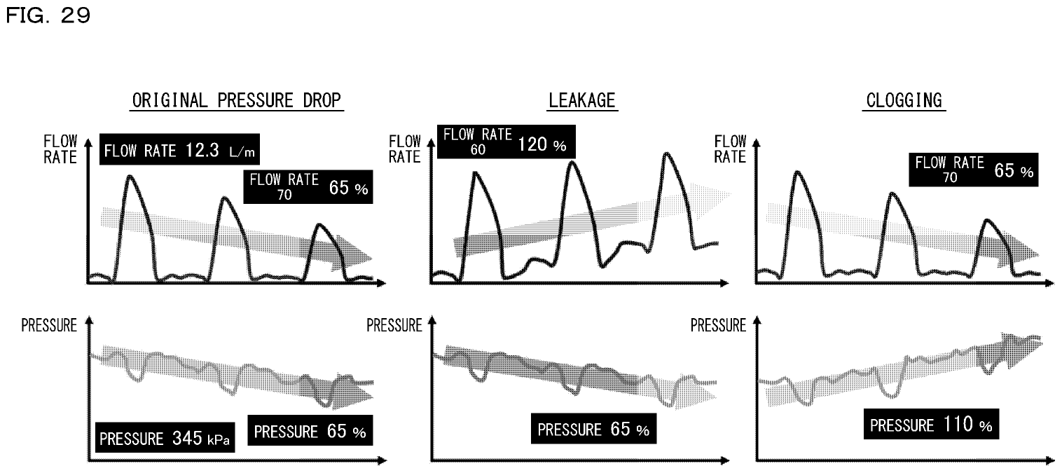

Further, when trends of the flow rate and the pressure are monitored as illustrated in FIG. 29, it is possible to grasp tendencies that both the flow rate and the pressure decrease. In a case where both the flow rate and the pressure are decreasing, the evaluation unit 73 evaluates that the original pressure drop occurs. Further, in a case where the flow rate tends to increase but the pressure tends to decrease, the evaluation unit 73 evaluates that a leakage occurs. Further, when the flow rate tends to decrease but the pressure tends to increase, the evaluation unit 73 evaluates that the flow path is clogged. In this manner, the evaluation unit 73 performs the evaluation based on pieces of the time-series data of the flow rate and the pressure, so that it is possible to distinguish a type of trouble when some trouble occurs in the pneumatic device.

### Functions and Effects of Embodiment

As described above, the use of the flow sensor A according to the present embodiment enables measurement of a flow rate and a pressure of a working gas flowing through a flow path in the pipe 100 connected to a pneumatic device. Since the evaluation unit 73 that evaluates an operation of the pneumatic device is provided in the flow sensor A, the evaluation of the pneumatic device can be performed using the flow sensor A without causing a user to separately prepare a diagnosis system for diagnosing the pneumatic device, and a burden of introducing the diagnosis system for the pneumatic device is mitigated. Further, the evaluation unit 73 can determine a characteristic amount indicating the operation of the pneumatic device using a combination of the flow rate of the working gas in the pipe 100 and the pressure of the working gas in the pipe 100, and evaluate the operation of the pneumatic device based on the determined characteristic amount. As a result, it is possible to perform prompt and accurate diagnosis as compared with a conventional case where the pneumatic device is diagnosed using only one physical quantity.

The above-described embodiment is merely an example in all respects, and should not be construed as limiting. Furthermore, all modifications and changes belonging to the equivalent range of the claims fall within the scope of the invention. For example, evaluation of a pneumatic device by the evaluation unit 73 can also be referred to as diagnosis of a pneumatic device.

As described above, the flow sensor according to the disclosure can be used to measure the flow rate of the working gas flowing in the pipe connected to various pneumatic devices.

What is claimed is:

1. A flow sensor comprising:
a flow rate measuring element configured to measure a flow rate of a working gas in a pipe connected to a pneumatic device and forming a flow path of the working gas;
a pressure measuring element configured to measure a pressure of the working gas in the pipe; and
an evaluation unit that determines a characteristic amount indicating an operation of the pneumatic device based on a combination of the flow rate measured by the flow rate measuring element and the pressure measured by the pressure measuring element, and evaluates the operation of the pneumatic device to which the pipe is connected based on the characteristic amount.

2. The flow sensor according to claim 1, wherein
the pipe is configured to be connectable to any one pneumatic device of a plurality of types of the pneumatic devices, and
the evaluation unit determines a characteristic amount corresponding to a type of the pneumatic device connected to the pipe, and evaluates an operation of the pneumatic device connected to the pipe based on the characteristic amount.

3. The flow sensor according to claim 2, further comprising a reception unit that receives, from a user, selection of a type of the pneumatic device connected to the pipe,
wherein the evaluation unit determines a characteristic amount corresponding to the type of the pneumatic device received by the reception unit, and evaluates an operation of the pneumatic device connected to the pipe based on the characteristic amount.

4. The flow sensor according to claim 2, wherein
the plurality of types of pneumatic devices include an air blowing device that ejects air as the working gas from a nozzle, and
in a case where the air blowing device is connected to the pipe, the evaluation unit determines a blowing amount, which is a mass flow rate of compressed air ejected from the nozzle of the air blowing device, as the characteristic amount and evaluates an operation of the air blowing device based on the blowing amount.

5. The flow sensor according to claim 4, wherein the evaluation unit evaluates that clogging of the nozzle occurs in a case where the blowing amount is equal to or less than a predetermined blowing amount and the pressure measured by the pressure measuring element is equal to or more than a reference pressure, and evaluates that a pressure drop of the compressed air supplied to the air blowing device occurs in a case where the blowing amount is equal to or less than the predetermined blowing amount and the pressure measured by the pressure measuring element is less than the reference pressure.

6. The flow sensor according to claim 2, wherein
the plurality of types of pneumatic devices include an air cylinder device, and
in a case where the air cylinder device is connected to the pipe, the evaluation unit determines a leakage amount and a thrust margin of the air cylinder device as the characteristic amount and evaluates an operation of the air cylinder device based on the leakage amount and the thrust margin.

7. The flow sensor according to claim 6, wherein the evaluation unit evaluates that deterioration of packing of the air cylinder device occurs in a case where the leakage amount when the air cylinder device is stopped is equal to or more than a predetermined leakage amount.

8. The flow sensor according to claim 2, wherein
the plurality of types of pneumatic devices include a suction conveying device that generates a negative pressure by ejecting compressed air as a working gas, and
in a case where the suction conveying device is connected to the pipe, the evaluation unit determines a suction speed and a suction force as the characteristic amount and evaluates an operation of the suction conveying device based on the suction speed and the suction force.

9. The flow sensor according to claim 8, wherein in a case where the suction force during suction is equal to or less than a predetermined force, the evaluation unit evaluates that deterioration of the suction pad included in the suction conveying device occurs.

10. The flow sensor according to claim 8, wherein in a case where the flow rate measured by the flow rate measuring element is equal to or less than a predetermined flow rate during suction, the evaluation unit evaluates that a pressure drop of the compressed air supplied to the suction conveying device or clogging of a flow path in the suction conveying device occurs.

11. The flow sensor according to claim 2, wherein
the plurality of types of pneumatic devices include a seating device using compressed air as the working gas, and
in a case where the seating device is connected to the pipe, the evaluation unit determines a volume flow rate of the compressed air ejected from the seating device as the characteristic amount, and evaluates an operation of the seating device based on the volume flow rate.

12. The flow sensor according to claim 11, wherein the evaluation unit evaluates that clogging of a nozzle of the seating device occurs in a case where the volume flow rate when a workpiece is not seated is equal to or less than a predetermined flow rate and the pressure measured by the pressure measuring element is within a predetermined range, and evaluates that a pressure drop of the compressed air supplied to the seating device occurs in a case where the volume flow rate when the workpiece is not seated is equal to or less than the predetermined flow rate and the pressure measured by the pressure measuring element drops below the predetermined range.

13. The flow sensor according to claim 1, wherein the evaluation unit determines the characteristic amount indicating the operation of the pneumatic device based on a combination of time-series data of the flow rate measured by the flow rate measuring element and time-series data of the pressure measured by the pressure measuring element.

14. The flow sensor according to claim 1, wherein the evaluation unit executes reference value determination processing of determining an evaluation reference value using a plurality of the flow rates and a plurality of the pressures respectively measured by the flow rate measuring element and the pressure measuring element when the pneumatic device repeats the operation, and performs the evaluation based on the determined evaluation reference value.

15. The flow sensor according to claim 14, wherein the evaluation unit repeatedly executes the reference value determination processing using the flow rate and the pressure acquired at a plurality of different timings until a degree of reliability of the evaluation reference value is equal to or higher than a predetermined degree of reliability.

16. The flow sensor according to claim 1, further comprising:
a flowmeter having a first body including the pipe as a built-in pipe, the flow rate measuring element coupled to the built-in pipe, and the pressure measuring element coupled to the built-in pipe;
a control unit having a second body different from the first body, the second body including the evaluation unit and a display unit displaying the operation of the pneumatic device evaluated by the evaluation unit; and
a connection line connecting between the flowmeter and the control unit.

17. The flow sensor according to claim 2, further comprising a reception unit that receives, from a user, selection of a type of the pneumatic device connected to the pipe; and a display unit configured to display a selection screen for the selection of the type of the pneumatic device,
wherein the evaluation unit determines a characteristic amount corresponding to the type of the pneumatic device received by the reception unit, and evaluates an operation of the pneumatic device connected to the pipe based on the characteristic amount, and
the display unit displays the operation of the pneumatic device evaluated by the evaluation unit.

18. The flow sensor according to claim 17, further comprising:
a flowmeter having a first body including the pipe as a built-in pipe, the flow rate measuring element coupled to the built-in pipe, and the pressure measuring element coupled to the built-in pipe;
a control unit having a second body different from the first body, the second body including the evaluation unit, the display unit and the reception unit; and
a connection line connecting between the flowmeter and the control unit.

19. The flow sensor according to claim 17, further comprising:
a single body including the pipe as a built-in pipe, the flow rate measuring element coupled to the built-in pipe, the pressure measuring element coupled to the built-in pipe, the evaluation unit, the display unit and the reception unit.
